(19) United States
(12) Patent Application Publication
(10) Pub. No.: US 2022/0084013 A1
(43) Pub. Date: Mar. 17, 2022

(54) IDENTITY MANAGEMENT, SMART CONTRACT GENERATOR, AND BLOCKCHAIN MEDIATING SYSTEM, AND RELATED METHODS

(71) Applicant: BlockRules Ltd, Fremont, CA (US)

(72) Inventors: Dhruva Deepak KULKARNI, Fremont, CA (US); Mateusz Wojciech POSPIESZNY, Fremont, CA (US); Pramod MADABHUSHI, Fremont, CA (US)

(21) Appl. No.: 17/423,840

(22) PCT Filed: Jan. 21, 2020
(86) PCT No.: PCT/US2020/014472

§ 371 Date: Jul. 16, 2021

Related U.S. Application Data
(60) Provisional application No. 62/794,396, filed on Jan. 18, 2019.
(60) Provisional application No. 62/794,400, filed on Jan. 18, 2019.

(51) Int. Cl. G06Q 20/36; G06Q 20/38

(52) U.S. Cl. CPC G06Q 20/3674; G06Q 2220/00; G06Q 20/3825

(57) ABSTRACT

A digital asset system comprises a user information system, a transaction machine instructions generator to produce machine instructions of a blockchain transaction, a signing module, a blockchain communications system that sends system-signed messages to a blockchain system, and a transaction mediating system that receives user input comprising a transaction data structure representing the blockchain transaction. The transaction mediating system can send machine instructions to other elements of the system in response to user input and machine instructions of the blockchain transaction for execution on a blockchain system. The signature module can generate a system-signed message with a digital signature associated with the digital asset system, (a) machine instructions of a transaction for execution on a blockchain system received from the transaction instructions generator or (b) a user-signed machine instructions of a transaction for execution on a blockchain system received from the transaction mediating system.

### CROSS-REFERENCES TO PRIORITY AND RELATED APPLICATIONS

This application claims the benefit of U.S. Provisional Patent Application No. 62/794,400, filed Jan. 18, 2019 entitled “Identity Management, Smart Contract Generator, and Blockchain Mediating System, and Related Methods,” and U.S. Provisional Patent Application No. 62/794,396, filed Jan. 18, 2019 entitled “Identity Management for a Distributed Network, Blockchain Mediating System, and Related Methods,” the disclosures of which are herein incorporated by reference in their entirety.

The entire disclosures of the following application(s)/patent(s) is(are) hereby incorporated by reference, as if set forth in full in this document, for all purposes:

U.S. Provisional Patent Application No. 62/732,491, filed Sep. 17, 2018 entitled “Transaction Authentication System and Related Methods”.

U.S. Provisional Patent Application No. 62/783,093, filed Dec. 20, 2018 entitled “Transaction Authentication System and Related Methods”.

U.S. Provisional Patent Application No. 62/732,532, filed Sep. 17, 2018 entitled “Computer System for Handling Securitized Token Contracts and Distribution Transactions”.

PCT Patent Application No. PCT/US2019/051594, filed Sep. 17, 2019 entitled “Transaction Authentication System and Related Methods”.

PCT Patent Application No. PCT/US2019/051580, filed Sep. 17, 2019 entitled “Computer System for Handling Securitized Token and Voting Contracts and Distribution and Voting Transactions”.

### FIELD OF THE INVENTION

The present disclosure generally relates to distributed computing systems over which transactions among nodes occur. The disclosure particularly describes apparatus and techniques for maintaining decentralized authorization for requested transactions on a distributed computing system in communication with off-chain centralized components.

### BACKGROUND

A transaction mediating system can facilitate, limit, and control transactions among transactors on a computer (transaction) network, as well as transactions to be inserted by one or more transactors into the transaction network, which may include the distributed ledger of a blockchain network. Some transaction networks might be set up such that transactors not meeting a predetermined set of requirements cannot engage in a transaction or are not allowed to insert a transaction into the transaction network for processing or execution. For example, a financial transaction mediating system might block attempts to insert a transaction into a transaction network, such as the distributed ledger of a blockchain network, if the party initiating the insertion has not been properly authenticated or if a computer process determines that the party lacks sufficient fiat currency funds for the attempted financial transaction in an account that resides outside the blockchain network. Transaction mediating systems might need more complex implementations dependent on the systems they are mediating.

### SUMMARY

In various embodiments, a digital asset system used in a networked computer environment processes transactions that relate to blockchain transactions. The system might comprise a user information system, comprising a user identity system comprising a database of addresses associated with each user of a plurality of users, and wherein the user identity system is configured to verify or operate on an address database, comprising records of holder addresses and token holdings, in response to machine instructions received, a transaction machine instructions generator, configured to generate machine instructions of a blockchain transaction for execution on a blockchain system, a signing module, a blockchain communications system configured to send a system-signed message to the blockchain system, and a transaction mediating system that receives user input comprising a transaction data structure representing the blockchain transaction, wherein the transaction mediating system is configured to send machine instructions to one or more of the user information system, the transaction machine instructions generator, the signing module, and/or the blockchain communications system, in response to the received user input. An output of the transaction mediating system might output digital messages comprising machine instructions of the blockchain transaction for execution on the blockchain system.

The transaction machine instructions generator might be configured to send the generated machine instructions of the blockchain transaction to at least one of the transaction mediating system and/or the signing module. The signing module might be configured to generate the system-signed message, provided to the blockchain communications system, by signing, with at least one digital signature associated with the digital asset system, (a) machine instructions of the blockchain transaction received from the transaction machine instructions generator, or (b) user-signed machine instructions of the blockchain transaction received from the transaction mediating system.

A digital asset transaction and management system, for use in a networked computer environment, might comprise a user information system, comprising a user identity system configured to verify and/or operate on a wallet database in response to machine instructions received by the user information system, wherein the user identity system comprises a database of addresses associated with each user of a plurality of users, and wherein the wallet database comprises records of wallet addresses and token holdings. The digital asset transaction and management system might also comprise a transaction machine instructions generator, configured to generate machine instructions of blockchain transactions for eventual execution on a blockchain system, a signing module that generates system-signed messages digitally signed with at least one system digital signature associated with the digital asset transaction and management system from input machine instructions, a blockchain communications system configured to receive system-signed messages from the signing module and inject those system-signed messages into the blockchain system, and a transaction mediating system that receives user input comprising a transaction data structure representing a first blockchain transaction and, in response to received user input, outputs a first set of generated machine instructions representing at least a part of the first blockchain transaction for eventual execution on the blockchain system to one or more of (1) the user information system, (2) the transaction machine instructions generator, (3) the signing module, and/or (4) the blockchain communications system, wherein the transaction machine instructions generator is configured to send the first set of generated machine instructions to at least one of (1) the transaction mediating system and/or (2) the signing module, and wherein the signing module is configured to generate the system-signed messages by signing (a) machine instructions of blockchain transactions generated by the transaction machine instructions generator, or (b) user-signed machine instructions of blockchain transactions received from the transaction mediating system.

The transaction data structure can represent a desired blockchain transaction or user-signed machine instructions of the desired blockchain transaction. The user information system might comprise a user financials system comprising a data structure including user financial information, and wherein the user financial system operates on user financial information in response to machine instructions received from the transaction mediating system. The user financial information might comprise one or more of account contents, user demographics, user reputation, and/or user identity as represented in the transaction mediating system.

A transaction mediating system may be a part of a digital asset system or a digital asset transaction and management system), that manages transactions of one or more types of digital assets, recorded on the distributed ledger of a blockchain network, wherein users can submit transactions into the digital asset system, which then employs the transaction mediating system to facilitate, limit, and control the transactions according to a set of predetermined rules and requirements, before the transaction(s) are passed on to the distributed ledger of a blockchain ledger for execution on the blockchain network. In further embodiments, the digital asset system, and its corresponding transaction mediating system, can be used to support more complex digital assets, recorded on the blockchain, that correspond to more sophisticated financial instruments such as financial derivatives, warrants, options, and short positions.

A method of facilitating transactions for a blockchain network is provided which may involve receiving, at a digital asset system, a request for a blockchain transaction, operating on user information of a user of a user node of the blockchain network, generating machine instructions for executing the blockchain transaction on a blockchain system, and sending the machine instructions to the user node.

The method might comprise verifying the user information, receiving, at a digital asset system, cryptographically-signed machine instructions of the blockchain transaction, signing, with a digital signature associated with the digital asset system, the cryptographically-signed machine instructions of the blockchain transaction to form multiplicatively signed machine instructions of the blockchain transaction, and submitting, to the blockchain system, the multiplicatively signed machine instructions of the blockchain transaction.

Another method might comprise receiving, at a digital asset system, cryptographically signed machine instructions of a blockchain transaction for execution on a blockchain system, signing, with a digital signature associated with the digital asset system, the cryptographically signed machine instructions, and submitting, to the blockchain system, multiplicatively signed machine instructions of the blockchain transaction, for execution on the blockchain system.

Each of these methods and apparatus might be implemented using an appropriately programmed processor with program instructions to effect each of the structures, components and elements, using known programming techniques to transform a general purpose processing system into a specific thing. The program code might represent a computer-implemented method for creating blockchain transactions, comprising receiving, at a digital asset system, cryptographically-signed machine instructions of a blockchain transaction for execution on a blockchain system, signing, with a digital signature associated with the digital asset system, the cryptographically-signed machine instructions to form multiplicatively signed machine instructions of the blockchain transaction, and submitting, to the blockchain system, the multiplicatively signed machine instructions of the blockchain transaction, for execution on the blockchain system.

Using these systems, transactions might be processed so that off-blockchain constraints can be imposed on user transactions, wherein a valid transaction includes indicia that the transaction satisfies some criteria of a network system operator that is not a criteria enforced on the blockchain network.

The following detailed description together with the accompanying drawings will provide a better understanding of the nature and advantages of the present invention.

### BRIEF DESCRIPTION OF THE DRAWINGS

Various embodiments in accordance with the present disclosure are be described with reference to the drawings, in which:

FIG. 1 illustrates a block diagram example of a system for decentralizing authentication requests on a blockchain system;

FIG. 2 illustrates a block diagram example of systems modules of a user device implementing a digital asset user application;

FIG. 3 illustrates a block diagram example of system modules of a digital asset system;

FIG. 4 illustrates a method for decentralizing authentication requests for bid transactions on a blockchain system;

FIG. 5 illustrates a method for cryptographically securing the addition of an address to a user's account on the digital asset system at a user's request;

FIG. 6 illustrates a method for mediating a user's desired transactions on a blockchain system using a digital asset system;

FIG. 7 illustrates an example flow;

FIG. 8 illustrates another example flow;

FIG. 9 illustrates yet another example flow;

FIG. 10 illustrates a computer system that can be employed to implement examples of the systems and methods disclosed in FIGS. 1-9.

### DETAILED DESCRIPTION

In the following description, various embodiments are described. For purposes of explanation, specific configurations and details are set forth in order to provide a thorough understanding of the embodiments. However, it should also be apparent to one skilled in the art that the embodiments may be practiced without the specific details. Furthermore, well-known features may be omitted or simplified in order to not obscure the embodiment being described.

Transactions among parties, which can be persons or entities or users, can be facilitated with transaction mediating systems that provide for imposition of predetermined rules on transactions that govern how transactors interact with and use a transaction network, which may include the distributed ledger of a blockchain network. The predetermined set of rules may be function of how a transaction network operates. A user might be a person or entity that or who is a participant in a transaction, such as a company or other organization, a computer system, or a smart contract that resides on a blockchain network as described herein. Users of a financial transaction clearinghouse might be constrained by how the clearinghouse operates, which in turn might be under the purview of various financial regulatory bodies. A distributed ledger system can perform computations that correspond to transactions submitted by one or more transaction participants.

Separate from a transaction validation process (such as by a consensus algorithm) of a blockchain network, applications may find use in authenticating or validating transactions submitted by one or more users based on a set of predetermined rules before they are injected into the blockchain network. This is a function that can be served by introducing a transaction mediating system that facilitates, limits, and controls transaction before they are injected into the blockchain network.

Transaction mediating systems may utilize known information about the user, such as user identity information, other state information recorded outside the blockchain network (so-called “external state information”), or state information also stored on a distributed ledger (so-called “internal state information”) and accessible by one or more smart contracts running on the blockchain network. The transaction mediating system is preferably secure in that only users with the proper user identity credentials (e.g., private keys) are allowed to have their transactions sent to the blockchain network for execution. The transaction mediating system need not itself execute the transaction in question, but can make appropriate conditional decisions based on one or more pieces of external state and/or user identity information, about whether a transaction submitted by one or more users is eligible for execution on the blockchain network. The transaction mediating system can be configured to only pass on a transaction to the blockchain network for execution provided the transaction meets a set of predetermined requirements or rules. Those rules or requirements could be distinct from a set of blockchain network rules applied by the blockchain network to validate a transaction as part of a network block. The transaction mediating system may be part of a digital asset system for digital assets recorded on the distributed ledger of a blockchain network.

A distributed ledger is a ledger implemented on a network of computers, which may be geographically distributed, wherein each member computer supports one or more computational nodes each of which may execute one or more computational processes and communicate to computational nodes on any other member computer of the network using cryptographic controls in order to support and manage a distributed ledger. Herein, the term “nodes” might refer to computational nodes. The distributed ledger contains records of processed blockchain transactions and is distributed in such a manner that copies of all or part of the ledger can exist at various nodes in the computer network.

The blockchain transactions might be grouped sequentially into collections called blocks. For ease of computationally verifying that a given copy of the distributed ledger is authentic, the distributed ledger might be stored as a blockchain, wherein validation of one block of the blockchain (within a statistically probable certainty) can occur only if all of the earlier blocks are valid and are unaltered from their original form existing at the time those blocks were added to the blockchain. In this blockchain scheme, users may use one or more nodes to post blockchain transactions containing references to transfers of value or information and once those blockchain transactions are grouped into a block and that block is accepted onto the blockchain, the blockchain transactions would become permanently recorded in that nodes would not accept altered blocks to replace the original blocks that were previously added to the blockchain.

The programming of the nodes may be such that one node would not accept a blockchain transaction or block from another node if that blockchain transaction or block appeared to be altered from the original. Alteration could be detected if each blockchain transaction and/or block were secured using a cryptographic protocol that would make it statistically impossible for a party to make an alteration and still have the blockchain transaction and/or block validate when it is cryptographically checked.

A blockchain can be represented in computer memory as a cryptographically-linked, ordered list of blocks and need not be bounded. Each block might contain blockchain transaction data about one or more blockchain transactions, a cryptographic hash of a previous block, and other metadata, such as a blockchain transaction timestamp. Generally a blockchain uses a cryptographic hash that is both deterministic, in that for any given block or set of blocks, there is one valid hash value that can be easily verified, and irreversible, in that it is not possible to fabricate an original block that matches a specific hash value without expending an impractical amount of computational resources.

Since the hash serves as a fingerprint of sorts for a block, and since any alteration of the block would result in a different hash, if the hash of a block is included in the data that is hashed in a later block, a node can easily check whether any of the blocks in a blockchain have been altered. As a result, a blockchain is resistant to data modification since the precise contents in any block can be verified at any time against the cryptographic hash contained in the subsequent block, such that a block cannot be retroactively changed without altering all subsequent blocks.

A distributed blockchain can be implemented on multiple nodes, wherein a node might be an instance of blockchain processing code executed on a computer and able to communicate with other nodes. The nodes may be geographically separated. In a typical implementation, each instance maintains a copy of the blockchain. Instances might communicate through a peer-to-peer network in order to maintain the integrity of the blockchain and obtain updates, such as new blockchain transactions or new blocks. In some cases, a consensus scheme might be used in advance to decide which version of the blockchain is authoritative in case of any discrepancy. Such consensus schemes are typically designed to favor the longest or most popular version of the blockchain. After validation, each node might operate under the assumption that its copy of the blockchain is the authoritative version without having to constantly run verification. In this manner, operations applied to one instance would be considered authoritative if queried by any other instance as long as that operation is encoded on a validated copy of the blockchain. A public distributed blockchain (PDB) is a distributed blockchain supported collaboratively by the general public, in that almost any interested party can install and operate a node on their computing equipment and connect their node to other nodes on the blockchain network. Since an interested party can join such a public distributed blockchain network at will, such a blockchain is considered publicly available and publicly accessible. Although a central authority might be needed to establish a set of rules under which the PDB operates (and perhaps provide the computer code needed for implementation), once launched, control of the PDB can be passed to a (presumably large) community of public users who set up nodes and follow the established rules. A properly implemented PDB that enjoys sizable and worldwide participation is practically impervious, as a whole, to unauthorized manipulation by any one party.

Before a node adds a block to the blockchain, the node should verify the blockchain transactions that are grouped into the block. In some distributed blockchain systems, the process of creating a block might include a requirement that the node perform some nontrivial computational process so that it is difficult for a node to freely generate possibly bogus blocks to add to the blockchain. The nontrivial computational process might involve a cryptographic or mathematical problem that is difficult to solve but where it is relatively easy to verify that a proffered solution is indeed a correct solution. As part of block generation, besides solving associated cryptographic or mathematical problems, the node can be expected to process all blockchain transactions that are to be grouped into the block to ensure that each blockchain transaction is valid.

A blockchain virtual machine (BVM) can be considered a computing environment that is encoded as blockchain transaction data on a distributed blockchain. A BVM may be considered a Turing-complete state machine, including a plurality of smart contracts, each of which are composed of sets of computer instructions and/or preserved data that is stored on the blockchain and accessible to the smart contract. A BVM environment uses the creation of validated blocks as a method for maintaining a self-consistent, singular global state of the BVM across all nodes running the BVM. Furthermore, because a BVM is implemented on a blockchain system, the execution of each computer instruction can be cryptographically verified. In addition, since a BVM is implemented on a distributed blockchain, instruction execution is secure, transparent, and decentralized. Unlike a traditional distributed blockchain, which may need to be rewritten and redeployed for each new application, a single BVM can support a number of independent applications that can be deployed at any date after the BVM is initiated and that are executable on the BVM. Each such application is written in computer code such that it can be introduced and executed on the computing environment provided by the BVM. It is often useful to consider the BVM as a general-purpose computing platform or system that is decentralized, transparent, and verifiable, but it should be understood that it is often implemented on computing nodes in a distributed computing system performing computations that perform the operations of the BVM.

In order to perform its functions, each application on a BVM responds to messages that originate outside the BVM, for example from a node that is passing on input obtained from a human user, either representing themselves or an organization, or from another computer executing preassigned instructions, such as a conventional computer service. Each message might be encoded with an address that corresponds to a unique identity of the source of the message. Some messages are cryptographically signed to ensure that the address cannot be forged. This is generally achieved by utilizing a cryptographic method such that a message can be readily and correctly signed by someone with knowledge of a secret key, password or passphrase(s), such that the message signature is easily verified by others, and such that the message cannot be correctly signed by someone without providing the secret key, password or passphrase(s). Thus, an application implemented on a BVM can use the address of the signed messages it receives to verify the identity of its users. In some BVMs, messages that cause, or could potentially cause, the state of the BVM to change must be incorporated into the blockchain ledger in order for the state and the blockchain ledger to remain consistent. Such messages may be considered to be blockchain transactions, even though the message is not necessarily associated with the transfer of any value are might not be considered a financial transaction in the conventional sense.

As mentioned herein, smart contracts, which can each be identified by a unique address on the BVM, can be implemented by, and represented by, ordered sets of machine-readable instructions associated with data stored on the blockchain and accessible to the smart contracts. These smart contracts, whether enacted on their own or working together with one another, can be used to perform one or more operations on the blockchain, including the enforcement of certain provisions as stipulated by set of rules, including, for example, the terms of a non-digital contract. As such, smart contracts can in principle be used to effectively control the ownership or transfer between parties of digital currencies or assets, including security tokens issued by an issuing party. In other blockchain environments, the smart contract may be embedded in the virtual machine environment through special blockchain transactions. After embedding the smart contract in the virtual machine environment, nodes operating as part of the blockchain network can evaluate blockchain transactions which reference the smart contract or directly invoke a portion of the smart contract in the form of one or more code functions calls. The smart contract processing might take in digital information as input, digitally process the information according to the rules of the smart contract, and digitally execute any actions as required by the terms and conditions of the smart contract.

Smart contracts can be implemented on a BVM of a blockchain system and can be executed at a node of a BVM as a collection of executable code and stored data in order to digitally enforce the provisions of an associated set of rules, including, for example, terms of a non-digital contract, provided the necessary digital information is available to the system executing the instructions of the smart contract. As an example, smart contracts can be used to determine whether an asset should go to a person (receiver) or should be returned to the person from whom the asset originated (sender).

Messages may be sent by one smart contract to another, in which case the message is associated with the address of the smart contract that initiated the message. In this fashion, users or processes outside the BVM may send blockchain transactions to an intermediate smart contract that then performs further blockchain transactions on their behalf by sending additional messages. When the intermediate contract is under the exclusive control of one party, any blockchain transactions that originate at the address of the intermediate contact are identified with the party that controls it.

A token might be a voucher implemented in a BVM that represents something of value, such as goods or services or future revenue, currency, or a unit of exchange. A specific class of token is typically implemented in an associated BVM application as a blockchain ledger that assigns a numerical quantity to individual addresses representing a current quantity of the thing of value represented by the tokens allocated to each address. Such tokens may then be transferred from one address to another by the BVM performing computational operations and recording the associated changes of state on the blockchain ledger. The rules for how such tokens are created, disposed of, assigned, and traded are embedded in the implementation of the associated BVM application, and as such, have the same characteristics of transparency and verifiability that are associated with the BVM as a whole. Tokens may represent securities interests, such as, but not limited to, shares of equity, units of debt, or contractual rights to a dividend or royalty. In such cases these tokens are referred to as “securitized tokens” or “security tokens.”

Token contracts are a type of smart contract that can record and perform actions with already existing tokens, generate or issue new tokens, and execute various transactions involving tokens. The individual or organization that is responsible for issuing the securities associated with a token is referred to as the token issuer. The issuer is generally responsible for publicly identifying the address of the token contract associated with the issued security and would be involved, directly or indirectly through a third party, with the implementation of the token contract. An individual or organization that has a nonzero balance of tokens is referred to as a token holder. A token holder would normally associate their holdings with one or more addresses under their control. An address under the exclusive control of a current or potential token holder (or “potential holder” for short) is referred to herein as a “holder address.” A holder address is therefore associated with a single and specific potential holder, whether it be an individual, a legal entity, or an organization. In various examples herein, a holder address, a blockchain address, a digital wallet address and/or a wallet address might be considered interchangeable and compatible.

A blockchain network might be used to manage, execute, record and/or publish transactions among users of the blockchain network. These users can be persons, entities, organizations, companies, institutions, computer systems, smart contracts, etc. who are able to inject or place transactions onto a blockchain ledger for execution by one or more smart contracts running on a BVM of a blockchain network. To prevent unauthorized users from injecting potentially false or unwanted transactions, each transaction is signed by the authorized user, typically using a private key, and transactions that are not signed or not correctly signed according to the blockchain system's cryptographic protocols are typically rejected by a node or nodes of the blockchain network and thus do not propagate throughout the blockchain network. Thus it is intended that only a user with proper user identity credentials (e.g., a private key assigned to the user by the blockchain network) can inject transactions into the blockchain. While important, this process alone does not determine whether the transaction is appropriate or allowable based on a predetermined set of (potentially external or off-chain) rules that govern such transactions that are to be potentially executed on the blockchain network as part of a transaction system and may be conditionally accepted or rejected by a transaction mediating system with access to external state information that is not recorded on the distributed ledger of the blockchain, as opposed to internal state information, which is stored on the distributed ledger of the blockchain and can be directly accessed by the smart contracts of a BVM.

A blockchain system can maintain internal state information in digital form as part of its associated distributed ledger. This internal state information, for example, might be a set of balances associated with one or more digital wallet addresses. The internal state information may be used as inputs to one or more smart contracts running on the blockchain system and such input may be scrutinized on-chain via smart contract(s) in order to determine whether to proceed with a transaction received by the blockchain network, as well as additional rules relating to specific operations allowed to be performed with the tracked digital assets represented by tokens recorder on the distributed ledger. A simple example is a transfer operation, where a user can send some digital currency (e.g., Ether on the Ethereum network) to a smart contract and in exchange obtain some tokens representing a different digital asset, such as purchasing tokens with Ether currency. Since this operation is fully blockchain-contained, smart contract(s) can make a trading decision based only on the internal state information and the payload of the incoming transaction.

However, in other scenarios, smart contracts may update its internal state in response to a transaction that came from outside of the blockchain network that is executing the logic of the smart contract. External inputs are typically passed as arguments of a member function that is invoked during the transaction. In such cases, the smart contract's execution might depend on external state information not present on the blockchain instead of being stored on the distributed ledger and not therefore directly accessible by the smart contracts running on a BVM, and instead rely on an intermediating system to process or otherwise analyze the external state information of the smart contract(s).

As a blockchain is typically distributed, authorization and control of what transactions are to be included in validated blocks are necessarily determined by the programmatic, cryptographic, and/or mathematical rules constructed as part of the blockchain network. Any user having access to a node of the blockchain network can create transactions and inject them into the blockchain network so that the transactions are appended to the distributed ledger, so long as the transaction is properly formed and signed by the user. This can make it difficult to enforce rules or transactions that involve external state or user identity information stored independently from the distributed ledger of the blockchain network or require actions or operations on external state information or materials separate from the relevant distributed ledger, as well as jurisdictional rules and other external rules that a user might be subject to that are not already built into the programmatic, cryptographic, and/or mathematical rules constructed as part of the blockchain network (herein referred to as “blockchain network rules”).

There could be some off-network legal constraints applied to a user, such as not allowing a user to make any transactions during a particular time period due to a legal injunction, settlement or by agreement, but if the user injected a transaction inconsistent with that user's external legal obligations, it would nonetheless propagate without a transaction mediating system, as that transaction would be consistent with the blockchain network rules of that blockchain network, but not of the external legal rules. Similarly, a transaction involving the transfer of tokens could be desired in response to an off-chain event, such as the sale or purchase of material goods. As long as the blockchain transaction were properly formatted and signed by the user, the transaction could be propagated by the blockchain nodes without any regard to whether the off-chain event ever occurred. To address such situations, a transaction mediating system can be constructed to effectively incorporate off-network constraints into transactions intended for execution on a blockchain network.

Consider two types of transactions: unconstrained and constrained for a blockchain network. Unconstrained transactions, with the exception of an authorized signature (e.g., private key) from a user (identified by the blockchain network through a public key or blockchain address), who is injecting the transaction into the blockchain network, may be adjudicated and executed based on internal state information and the blockchain network rules for the blockchain system. An unconstrained transaction might for example involve the spending of cryptographic or digital tokens representing digital assets by which the act of ‘spending’ transfers control of the tokens from a sending user to a receiving user. In that case, the transaction need be only signed by the sending user for the blockchain network nodes to consider the transaction valid. Constrained transactions, wherein the transaction must comply with one or more off-chain requirements or rules or requires analysis of external state or user identity information (including user identity information other than a private key and one or more registered blockchain addresses) are different and requires additional processing outside the blockchain network. For example, perhaps in addition to a user's public key or holder address and private key, they must be a resident or citizen of a permitted list of countries in order to have a certain constrained transaction executed. In another example, perhaps a constrained transaction can only be executed if the user can demonstrate a certain balance of fiat currency in an off-chain bank account. In yet another example, perhaps a constrained transaction can only be executed if an off-chain event has occurred or a particular off-chain state has been achieved. In one such embodiment of a blockchain network, constrained transactions are directly supported; wherein the blockchain network nodes do not consider the transaction valid unless the transaction is additionally signed by a mediating party. This might be implemented by programming nodes of the blockchain system to directly handle constrained transactions, and by extension smart contracts if implemented on a public distributed BVM, such that they verify at least two signatures before processing a transaction, where one signature is associated with the user initiating the transaction and one signature is associated with a mediating party. In some embodiments, the mediating party is a digital asset system or digital asset system operator.

In an operation of such an embodiment of a blockchain network, the mediating party might implement off-network constraints and only sign transactions that meet those constraints. For example, the mediating party might be a regulatory body, a guarantor, a custodian, or other mediator. As an example, one constraint might be that the transaction participants must first be “know your customer/anti-money laundering” (KYC/AML) verified before their holder addresses are added to on-chain user identity management system. In that case, the mediating party would perform all the necessary verifications such as identity verification, residency verification, etc. before signing the transaction to add user's blockchain address to an on-chain address database or map. In another example, the transaction might require operation on financial assets independent of the blockchain system (e.g., purchasing tokens with fiat currencies stored in a bank account; or purchasing a quantity of tokens representing a digital asset and instantiated on one blockchain system with a different quantity of tokens representing a different digital asset and instantiated on another, independent, blockchain system). In this example the mediating party would perform off-network verifications including, but not limited to, identifying the purchasing user's possession of the necessary funds off-chain in a bank account or in a digital wallet on another blockchain network, locking or restricting the movement of those off-chain assets until a certain time by means of electronic banking infrastructure (in case of fiat currencies) or jointly-signed wallets (in case of alternative tokens, potentially existing on other blockchain networks), and withdrawing or transferring the purchasing user's off-chain funds. For these operations, the mediating party need not have any particular control over the blockchain network or blockchain network rules.

Other examples of operations requiring off-chain constraints and examination of external state or user identity information might include adding new holder addresses to an account on a digital asset system, linking holder addresses for common ownership and/or recovery on a digital asset system, locking a digital wallet address against transactions, unlocking a digital wallet address, setting up a recovery address linked to other holder addresses owned by the same user in the event that a private key for one of the other linked holder addresses is lost or otherwise compromised, placing a bid for an amount of tokens representing a digital asset on a blockchain network as part of an auction such as during an issuance of a securitized token, transferring tokens representing digital assets between two or more transaction participants on a blockchain network with balances recorded on a distributed ledger, arranging for periodic payments from one or more digital wallet addresses, or other similar actions or transactions.

In another example, a user may want to execute a peer-to-peer transfer of their security tokens to another user. To do so, a user, identified by their public key to the blockchain network, first signs the transaction with the private key of an address holding their security tokens and sends the signed object to mediating party. The mediating party then might send the transaction to the blockchain smart contract, e.g., submit the transaction such that the blockchain attaches it to the smart contract. This allows mediating party to pay the blockchain transaction fees on behalf of the user. This allows mediating party to offer a transfer service to the users holding tokens.

In another example, user may want to give an allowance (for example as per the ERC-20 token standard) to another user such as a broker to withdraw a given number of securitized tokens representing a digital asset on their behalf. In some embodiments involving securitized (or security) tokens, a user signs the transaction with the private key of the address holding the securitized tokens and send the signed object to mediating party which will then send the transaction to one or more smart contracts running on a BVM of a blockchain network. This allows the mediating party to pay the blockchain transaction fees on behalf of the originating transactor, typically the sender of the transaction.

In some embodiments, the mediating party is a transaction mediating system of a digital asset system or digital asset system operator. In yet another embodiment, a user submits their signed transaction to the transaction mediating system of a digital asset system or digital system operator, after which the transaction mediating system certifies if the transaction complies with all of a set of off-chain rules based on external state or user identity information, at which point, if the transaction passes inspection, the transaction mediating system signs the transaction with its own private mediating key and sends the transaction to smart contract(s) running on a BVM of a blockchain network; wherein the smart contract(s) are configured to only take action if they see both signatures, at which point, the transaction may be authenticated via, perhaps additional smart contract(s), operating on internal state information accessible on-chain and only then completing final validation of the transaction on the blockchain with the result of a change of internal state information, such as, for example, updating digital asset balances for one or more digital wallet addresses, recorded on a distributed ledger of a blockchain network.

Other examples of off-network constraints are contemplated, with regard to address linking, setting up recovery and similar actions or transactions.

Transactions that require more than one mediating party to agree to a transaction are contemplated. Transactions that require a mediating party, but allow for selection among several mediating parties are also contemplated. For example, a transaction might be accepted by nodes of the network with only one of three possible mediating parties signing the transaction.

Other examples of mediating parties are possible, but one mentioned here is that of a transaction mediating system of a digital asset system or digital asset system operator. The digital asset system might handle all or most of the technical details for users, somewhat shielding them from the complexity of the blockchain network, but would still require user authorization via their electronic signature such as signature with their private key for a given holder address, for any transactions injected on the users' behalf. Such user authorization may be orchestrated by means of an app on a user device that communicates with the digital asset system, and hence the transaction mediating system. Though facilitated by the app, to ensure user authorization for blockchain transactions, the user can cryptographically sign (according to a public/private key cryptography method such as, but not limited to, ECDSA, RSA, etc.) machine instructions for executing the transaction on the blockchain which is then forwarded to the digital asset system and ultimately to the blockchain system.

In this manner, the digital asset system or other mediating party operations could provide for a supervisory control and management of certain transactions over a distributed computing system that operates according to decentralized authorization for requested transactions.

In a specific example, transactions might relate to transactions involving tokenized (or digital) assets and, in order to comply with securities laws in various jurisdictions, a mediating party, such as the transaction mediating system of a digital asset system or system operator, may verify personal and/or financial information of users and/or operate on users' financial information before submitting, or agreeing to sign off on, certain transactions to be injected into the blockchain network. Transactions might include a portion of token or crypto currency that can serve as a service fee that accrues to a blockchain network operator.

The transactions could be a simple transfer of value, such as transferring control over spendable tokens representing digital assets from a sending user to a receiving user, or transactions could more particularly adapted to specific functions of a blockchain network or blockchain networks employing smart contracts. A smart contract could be an auction contract that represents data and rules about maintaining, calculating, and distributing allocations of a supply of digital assets, such as securitized tokens based on bid transactions. It may be such that, at some time determined by the auction contract, securitized tokens are proportionally distributed to purchasers according to a ratio of a user bids against the sum of all users' bids placed and accepted within a selected timeframe.

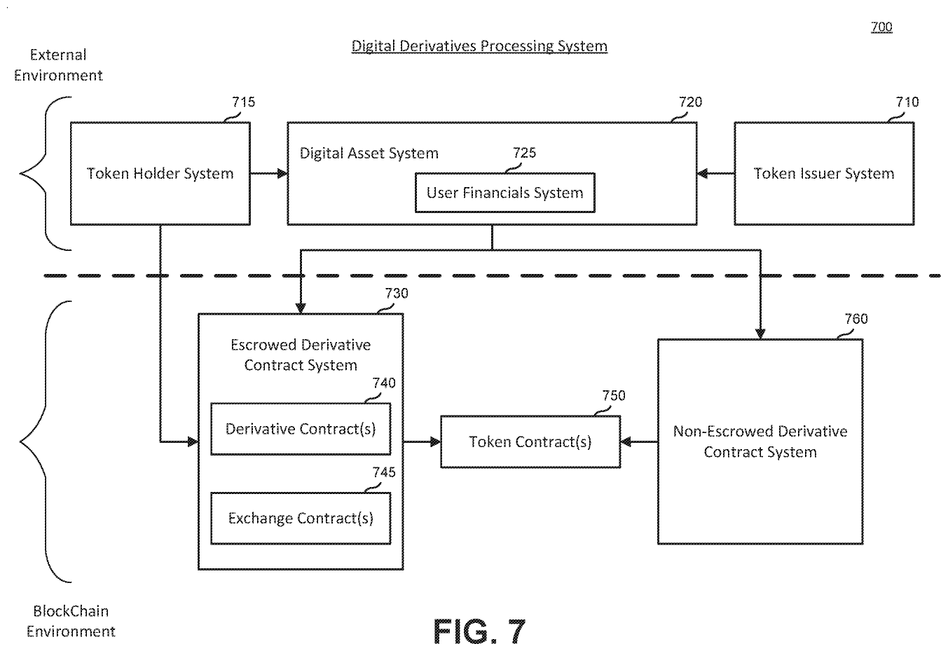

Furthermore, the digital asset transaction and management system can mediate transactions that require publishing of new smart contracts to the blockchain system. In some embodiments, these new smart contracts can allow for trading of derivatives (e.g., warrants, options, etc.) based on fundamental tokens held by token holders. Examples of this are illustrated in FIGS. 7-9 and described accordingly in the descriptions for those figures.

For example, a token holder in possession of tokens within a digital wallet may wish to issue a warrant or option to other users on the basis of their token holding or on a subset of their token holdings. These warrants or options can be represented as new tokens on the blockchain system managed by corresponding new smart contracts that have been instantiated on the blockchain system by a hashed and verified transaction within a block. In a specific example, the new tokens correspond to derivative tokens on the blockchain system managed by corresponding new smart derivative contracts that have been instantiated on the blockchain system by a hashed and verified transaction within a block.

In many embodiments, a digital asset transaction and management system that supports the derivative contracts can facilitate ownership of derivative tokens (e.g., option tokens, warrant tokens, etc.) among digital wallet addresses as well as the exchange of these derivative tokens (along with any additional payment) for the fundamental token during the exercise transaction for the derivative token. The fundamental token might be an original token on which the derivative token is offered.

A digital asset transaction and management system can mediate such transactions that publish derivative contracts to a blockchain system in order to ensure compliance of a variety of factors (e.g., the token holder issuing the derivatives is indeed in possession of the fundamental tokens, the derivative contracts adequately encode the parameters of the intended exercise rights, etc.) Additionally, the digital asset transaction and management system can ensure that the derivative smart contracts are properly encoded to lock or restrict the transfer of an appropriate number of fundamental tokens in the derivative issuer's digital wallet(s) or another digital wallet or smart contract storing the fundamental tokens to guarantee that the fundamental tokens are available upon exercising the derivative tokens.

In some embodiments, when users exercise derivative tokens to acquire fundamental tokens in a ratio (and subject to any other applicable contractual terms) encoded in the derivative smart contracts, the derivative smart contracts effect a transfer of the fundamental tokens from the balance of locked tokens in the issuer's digital wallet(s) or another digital wallet or smart contract storing the fundamental tokens. Furthermore, the digital asset transaction and management system can mediate transactions involving the derivative tokens (such as a transaction that exercises one or more derivative tokens).

A digital asset transaction and management system that mediates transactions involving derivative tokens allows those transactions to be coordinated with off-chain events, such as a withdrawal or depositing of fiat currency in a bank account. In other embodiments, similar contracts can be employed to allow short trading between two users. In those embodiments, the derivative contracts allow for a temporary borrowing of fundamental tokens under specific parameters that are encoded into the derivative contracts. Smart contracts allowing for short trading can be considered a type of derivative contract. Other such transactions that publish smart contracts to a blockchain system are contemplated.

Using some of the processes described herein, the digital asset transaction and management system can generate controlling transaction authentication data that eventually reside on the blockchain network that controls, limits, validates, etc. a derivative transaction, so as to enforce expected or other constraints on that derivative transaction that are not constraints that are imposed by the blockchain network rules. By controlling the derivative transaction, the digital asset transaction and management system can effectively restrain a derivative transaction on the blockchain so that it cannot be spent, transferred, etc. without approval of the entity controlling the digital asset transaction and management system that are in addition to any restraints imposed by the blockchain (e.g., the transaction cannot be transferred to another digital wallet address without approval of the current owner—as signified by being signed by the current owner's digital wallet address credentials, the transaction cannot result in double spending, the transaction may be reverted by the blockchain if it was validated and posted on an abandoned ‘uncle’ chain as with the Ethereum Network, etc.).

The digital asset transaction and management system might be a computer system that is programmed by an entity that is a regulatory agency, a trading exchange, a custodian, a transfer agent, a registrar, a broker, or a guarantor of transactions. The digital asset transaction and management system might include a transaction mediating system. Thus, transactions signed or controlled by the digital asset transaction and management system and known by participants in a blockchain network to be signed or controlled in this manner (along with the originating transactor's verifiable signature, typically the signature of the sender of the transaction) might be accepted and processed by some nodes of the blockchain network that would not otherwise be accepted and processed if not so signed or controlled by a digital asset transaction and management system even if the transactions would otherwise completely validate within the blockchain network on the basis of the blockchain network rules and a valid signature from the originating transactor and might otherwise be accepted as part of a validated block by other nodes of the blockchain network.

For implementing a system for decentralizing authentication requests as might, for example, be done with a digital asset system that performs off-network constraints checking and signing transactions to be passed on to a blockchain network, the digital asset system might maintain a database of user identity information comprising at least one digital cryptographic public key and digital wallet associated with each user, at least one digital cryptographic public and private key associated with the digital asset system, a list of user digital wallet addresses and associated public keys on the distributed computing system, and the like.

In more advanced applications involving a digital asset system, though, an off-chain state can be used as an input to the smart contract logic such as passing user inputs as arguments to member functions of the smart contract as part of a transaction to perform an operation. For example, if the purchase of a token at issuance allows multiple security tokens or cryptocurrencies as payments, the smart contract might require current exchange rates between various digital assets or cryptocurrencies to be published on the blockchain thus mapping external real world state/information onto the blockchain network. If an off-chain resource is used as a payment, or decision needs to be based on off-chain state, other steps might be needed. For example, to allow a user to pay in fiat currency for one or more security tokens might require additional steps. For a contract to perform such a transaction, the current account balance for the source account might be checked to ensure it is published to the contract and the amount used is locked out, so that it will not be double-spent or withdrawn by the prospective purchaser.

As part of a digital asset system, a smart contract could be written that encodes a logic that requires a transaction to be approved by a third (off-chain) party, such as an account balance holder or an escrow holder. In such cases, a user might invoke a smart contract method that indicates intent to purchase some tokens and the amount they are going to pay in the fiat currency in exchange. Some external process, such as an oracle, would then monitor the blockchain network for specific transactions/events and upon seeing this transaction or its generated specific event (e.g., event written into Ethereum network event log when the originating transactor submits their transactions to the blockchain network), it will check a specified account balance off-chain, place a hold on the appropriate amount of funds (perhaps utilizing a stored exchange rate) and then issue a counter-transaction to the same blockchain network to indicate that the funds have been locked and the transaction is approved to go through. Note that this introduces synchronous dependency on an external process and increases transaction latency and complexity.

Another alternative is for the system to require placing funds in escrow first, before they are allowed to be used in a smart contract transaction. A user works with third party to transfer a set amount of fiat currency into a bank escrow account. When the funds are transferred, the escrow holding party will publish a transaction on the blockchain, to record that this amount is now available for the purchase. Subsequent smart contract operations can then draw down this balance to immediately fund the operation, without requiring an oracle to provide a counter-transaction with an approval. This reduces system latency and is closer in spirit to pure-blockchain operation, but has the side effect of publishing all account balances on public network. In some use cases, such as auctions, having an openly published set of total funds available for operation is detrimental to the overall operation, as users can hedge their bets and potentially game the auction or gain an unfair advantage depending on when they bid and what is known.

In a digital asset transaction and management system, as described herein, a hybrid solution is provided wherein a smart contract can only accept transactions from the specified authorized address, such as that associated with the digital asset system, so only transactions that are pre-vetted are allowed to be submitted, but these transactions generally would also have an additional requirement that they be cryptographically signed by the originating transactor, such as by a private key that is only known to them and not to the digital asset system.

This split of responsibilities allows for the sending user's agency to be preserved, as only transactions explicitly approved by that user can be submitted, but also the sending user needs to be preapproved before their transactions can be submitted to the blockchain network, otherwise they will be ignored by the smart contracts interacting with the digital asset system. So, in practical terms—user asks for operation to be invoked, the transaction mediating system, as part of the digital asset system, checks if that operation is viable, based on various external state and user identity information, and thus can proceed. If it can proceed, the current state is recorded (e.g., holds placed on pledged resources, whether off-chain or on another blockchain network) and the transaction is signed by the transaction mediating system and submitted to the blockchain. The smart contract(s) interacting with the digital asset system then check both signatures—of the submitter (such as a mediating party or mediating system) and the originating transactor, and checks the content of the double-signed transaction object; to make sure that the submitted signatures matches the hash of the transaction. Only then will one or more smart contracts execute the transaction to completion.

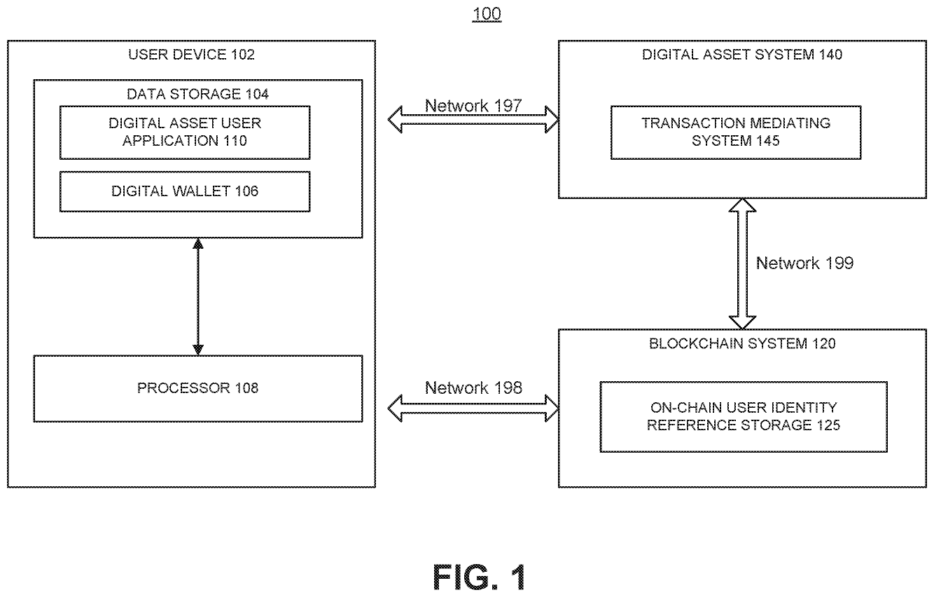

FIG. 1 shows a block diagram of a system 100 for maintaining decentralized authorization for requested transaction on a blockchain system. For the purposes of this and the other figures, while in many cases the user may be a person, in some cases, the user may actually be an organization, a company, an institution, a computer system, or another smart contract, though in the latter two cases the digital user application 110 would, for example, likely instead be a digital user application interface (API). The system 100 includes a user device 102, and a digital asset system 140, which includes a transaction mediating system 145, all in communication with each other via a network 197 and all in communication to a blockchain system 120 that may be a public distributed BVM, via network 198 and network 199. It should be understood that a plurality of user devices might be present and a plurality of blockchain systems might be present.

The networks 197, 198, and 199 can be all portions of the same network (e.g., the Internet) or separate networks (e.g., one or more local intranets). Networks 197, 198, and 199 can implement various communication protocols such as HTTP, TCP/IP, UDP, etc. without leaving the scope of the disclosure. In certain embodiments, the user device 102 need not be in communication to the blockchain system 120.

The user device 102 includes a hardware processor 108 operatively connected to electronic data storage 104 such as volatile or non-volatile memory. The user device 102 implements a digital asset user application 110 and a digital wallet 106. The digital asset user application 110 is program code implemented on the user device 102 that facilitates user interaction with the digital asset system 140 and therefore the blockchain system 120 as well. The digital asset user application 110 is responsible for presenting communications from the digital asset system 140 to a user and facilitates a user's cryptographic signing of machine instructions intended for the blockchain system 120. In certain embodiments, a user can also submit user information such as one or more holder addresses, personal demographic information (e.g., name, age, country of residency, etc.) and financial information (e.g., bank account numbers and balances, etc.) to the digital asset system 140 via the digital asset user application 110. A digital wallet 106 can be a data structure used to store associated data on common or dedicated electronic data storage (e.g., RAM, or a hard-drive) and is associated with a holder address. In certain exemplary embodiments, the digital wallet 106 can be stored on a dedicated storage hardware that is implemented externally from the user device 102 but in communication with the system 100 for at least a time necessary to complete a transaction (e.g., via a communication link or local bus connections). In certain embodiments, dedicated hardware devices, such as a hardware security module (HSM), can be used to store information associated with the digital wallet 106.

The digital asset system 140 can be one or more computing systems in communication with each other and in communication with the reminder of the system 100, and is responsible for organizing user information (e.g., user wallet addresses, financial information, etc.), communicating with user devices 102 and the blockchain system 120, and generating machine instructions for blockchain transactions for execution on the blockchain system 120. In addition, the digital asset system 140 has at least one set of associated private and public cryptographic keys. In response to user requests for a transaction received from a user device 102, the transaction mediating system 145 corroborates and/or operates on available, applicable external state or user identity information stored locally to the digital asset system 140 or communicatively coupled to the digital asset system 140 to either deny or approve a transaction according to predefined conditions or constraints of interest to the mediating party controlling the digital asset system 140. If the transaction mediating system 145 of the digital asset system 140 approves a transaction, then the digital asset system 140 can generate machine instructions for executing the user's desired transaction on the blockchain system 120. The digital asset system 140 then sends the machine instructions as a digital message to the user device 102. The user can then sign the message with their private key using a private/public key cryptography protocol (e.g., ECDSA, RSA, etc.) via the digital asset user application 110. In some embodiments, the digital asset system constrains the user so that they must sign with their private key each time thereby withholding the private key itself from the digital asset user application 110. In other embodiments, the user can choose to store their private key on the digital asset user application 110 to streamline the process. In some embodiments, a user can be in possession of more than one sets of private and public keys and picks a set to use for any given transaction.

Once the user signs the machine instructions for the desired transaction via the digital asset user application 110, the digital asset user application 110 then returns a digital message comprising the signed machine instructions to the digital asset system 140. The digital asset system 140 verifies the signature by the implemented cryptography protocol to confirm the origin of the received message. If the digital asset system 140 succeeds in verifying the digital message, and the transaction mediating system 145 approves the user's transaction, the digital asset system 140 then signs the user-signed digital message with a private key associated with the digital asset system 140, and submits the doubly-signed message to the blockchain system 120 as a blockchain transaction. This process can be expanded to allow for any number of parties to sign the digital message with unique cryptographic key signatures and is contemplated herein. It should be appreciated that the digital message that contains the machine instructions for the transaction that is signed by multiple parties in a predetermined sequence can include additional information relevant for the implemented cryptography protocol (e.g., ECDSA, RSA, etc.) as well as any other data. This additional information can be appended to the digital message by either the digital asset user application 110 or by the digital asset system 140 at any step in the process of generating, providing, and sending the final signed message. This additional information can include timestamps and at least one nonce.

Transaction mediating system 145 adds an additional unique layer to security for execution of blockchain transactions. The user in some embodiments may have to supply a password or specific secrets directly to the digital asset system 140 in order to get the second signature. This essentially means that the user has to prove identity to the blockchain by signing with private key and prove identity to the digital asset system with password and possibly using two factor authentication. Smart contracts might be configured to only take action when both signatures if two different types arrive together.

The blockchain system 120, implemented across any number of nodes, can be a public distributed BVM such as that of the Ethereum Network employing smart contracts. In embodiments incorporating smart contract functionality, the smart contracts interacting with the digital asset system 140 and its associated users and user devices are coded such that transactions are only authorized on the blockchain system 120 if the nodes of the blockchain system 120 are able to verify at least two signatures of the transaction, such as one associated with the digital asset system 140 and another associated with the user. In certain embodiments, the digital asset system 140 might maintain a list of user wallet addresses in a smart contract on the blockchain system 120 to facilitate verification of the transactions. This storage of users' wallet addresses might use the on-chain user identity reference storage 125.

When utilizing the ECDSA encryption protocol for multiplicatively-signed messages, local storage of all users' wallet addresses appropriately indexed on the blockchain ledger of the blockchain system 120 reduces the amount of data required in the machine instructions of the transaction itself by replacing a user's lengthy wallet address with a shorter index value or hash. In other embodiments, the blockchain system 120 is not a public distributed BVM but is custom-built. In those embodiments, the custom-built blockchain system might be configured to require multiple signatures for approval of certain transactions and employ a separate data structure for the storage of user wallet addresses. This can be analogous functionality to employing smart contracts on a BVM. Commonly-owned wallet addresses can be stored on the blockchain system indexed by a unique hash identifying their common ownership or stored in a map associated with a user. In other embodiments, the custom-built blockchain would also allow for publishing data structures analogous to derivative contracts as in embodiments described herein.

When referencing actions and/or constraints of a smart contract herein, it should be understood that such actions might be performed by a computer system that is programmed to follow constraints indicated in the smart contract with the result of a change of internal state information, such as, for example, updating digital asset balances for one or more digital wallet addresses, recorded on a distributed ledger of a blockchain network.

For example, a smart contract SC1 can impose a prior constraint of not performing an action A1 unless a condition C2 is true and action A1 might involve initiating a transfer T3. Such details could be referred to as smart contract SC1 preventing transfer T3 when condition C2 is not true or could be referred to as a computer system having access to, or knowledge of, smart contract SC1 being programmed to test for condition C2 prior to initiating transfer T3. Where a blockchain network comprises nodes that are all constrained to follow requirements set forth in smart contracts they are aware of, blockchain network operations can effectively correspond to constraints imposed within a smart contract.

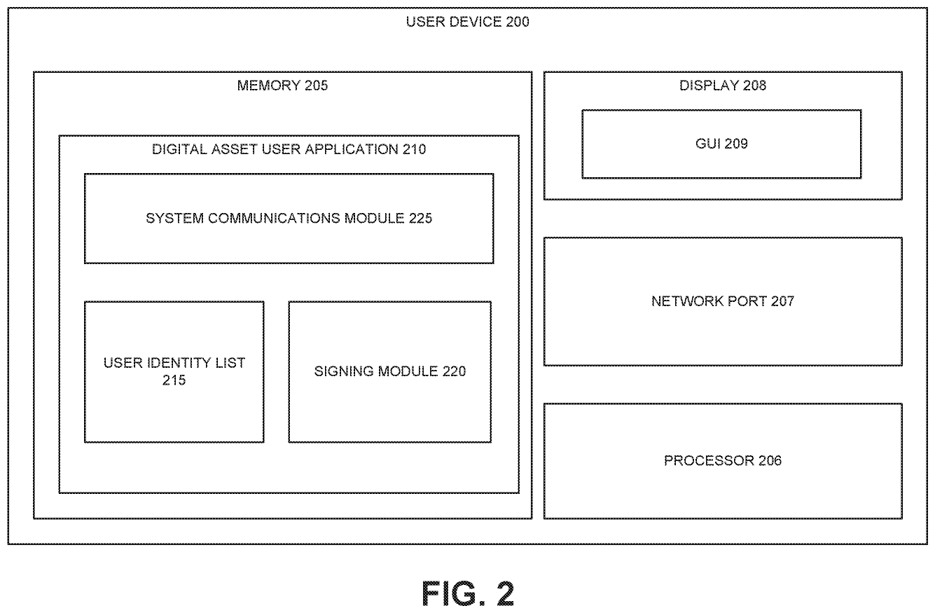

FIG. 2 shows a block diagram of a user device 200 that might be used in implementing a digital asset user application 210 both which can be the user device and digital asset user application illustrated in FIG. 1 in certain embodiments. The user device 200 comprises a processor 206 operatively in communication with memory 205 implementing the program code of the digital asset user application 210. The digital asset user application 210 is able to present a GUI 209 on a display 208 that is operatively connected to the memory 205 implementing the digital asset user application 210. The digital asset user application 210 can communicate to the digital asset system 140 via the network port 207 of the device employing known networking protocols. In other embodiments, the user device 200 can employ at least one digital wallet.

The digital asset user application 210 comprises a system communications module 225, a user identity list 215, and a signing module 220. Through the GUI 209 on the display 208 using an input device, a user communicates what type of desired actions the user would like the digital asset system 140 to perform. These actions can include blockchain transactions such as a spending or transferring of tokens a user has the right to spend or transfer, placing a bid for tokens on an auction contract, etc. These actions can also include system transactions such as submitting user information and/or user financial information to the digital asset system 140 for storage locally on the digital asset system 140. When a user selects a desired action and provides relevant additional information (e.g., text field entries of user information, new wallet addresses in the user's possession, desired total number of tokens to be transferred/bid upon, etc.), the system communications module 225 parses the selections and additional information into machine instructions and sends the machine instructions to the digital asset system 140 via the network port 207 of the user device 200.

It should be appreciated that other contemplated embodiments of the digital asset user application 210 include alternative groupings, arrangements, and selections of the parts depicted in FIG. 2. In other embodiments, certain functionalities can be redistributed as alternative implementations in a greater, fewer, or equivalent number of components.

In many embodiments, when a user requests a blockchain transaction the digital asset system will return digital messages to the digital asset user application 210 comprises machine instructions for the desired transaction on the blockchain system. Transactions can include transactions that publish smart contracts such as derivative contracts to the blockchain system as described in embodiments described herein. In some embodiments, these messages include text that summarizes the intended transaction (e.g., transaction type, quantity of tokens involved, recipient parties/wallet addresses, etc.). The user device 200 receives these messages via the network port 207. Using the GUI 209, the system communications module 225 prompts the user to review these messages. If the user wishes to cancel a rejection (e.g., because of an error in the transaction summary, because the user no longer desires the transaction, etc.) the user can cancel the proposed transaction by using an input device to communicate this intent on the GUI 209 to the system communications module 225 of the digital asset user application 210. The system communications module 225 can then communicate this termination to the digital asset system 140.

If a user indicates a desire to proceed with the transaction and communicates as such using an input device, the system communications module 225 via the GUI 209 prompts the user to cryptographically sign the machine instructions for the transaction and/or the entire digital message itself for return to the digital asset system 140. The user signs the message by selecting a user identity from the user identity list 215 via the GUI 209. In some embodiments, the user identity list 215 comprises a database of public keys and/or wallet addresses that the user has previously registered with the digital asset system. After an identity from the user identity list 215 has been selected, the system communications module 225 forwards the machine instructions for the blockchain transaction to the signing module 220. Via the GUI 209 the user provides the associated private key for the selected identity to the signing module 220; thereafter, the signing module 220 signs the machine instructions for the blockchain transaction as a user-signed message, returns the message to system communications module 225 that subsequently forwards the message to the digital asset system 140 via the network port 207. In another embodiment, the signing module 220 additionally signs the entire digital message comprising the signed machine instructions for the blockchain transaction. In some embodiments, the system communications module 225 may append additional data to the user-signed message in order to facilitate the message's transmission to the digital asset system 140. In certain embodiments, the digital asset user application 210 requires the user to provide the associated private key each time a transaction needs to be signed, thereby avoiding permanent storage of the private key in a data structure accessible to the digital asset user application 210, perhaps for security reasons. In alternative embodiments, the user identity list 215 also comprises private keys associated with each public key and/or wallet address. In these embodiments, when a user selects an identity for the signing of machine instructions for a blockchain transaction, the user identity list 215 forwards the relevant private key to the signing module 220 for automatic signing.

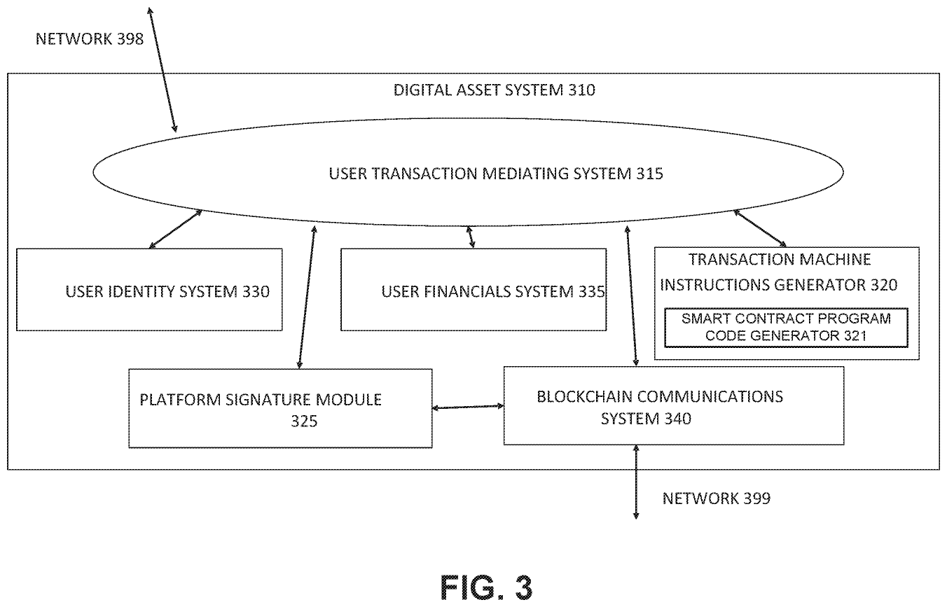

FIG. 3 shows a block diagram of a digital asset system 310 that can be used for the digital asset system 140 illustrated in FIG. 1 in certain embodiments. Other contemplated embodiments of the digital asset system 310 might include alternative groupings, arrangements, and selections of the parts depicted in FIG. 3. In other embodiments, certain functionalities can be redistributed as alternative implementations in a greater, fewer, or equivalent number of components.

The digital asset system 310, which is one or more computing systems, comprises a transaction mediating system 315 that receives input from user devices and can return messages to user devices over a network 398 (e.g., the Internet, an intranet, etc.); a transaction machine instructions generator 320 that procedurally generates properly formatted machine instructions for a blockchain transaction in response to input from the transaction mediating system 315; a system signature module 325 capable of automatically cryptographically signing blockchain transaction machine instructions received from the transaction mediating system 315 with at least one private key associated with the digital asset system 310; a user identity system 330 that stores user biographic information (e.g., name, country of residency, etc.) as unique user accounts as well as all addresses associated with each account; a user financials system 335 that stores and operates on users' financial information (e.g., bank account numbers, balances); and a blockchain communications systems 340 that submits fully signed transactions to a blockchain system over a network 399. In some embodiments, network 398 and network 399 are portions of a common network.

The transaction mediating system 315 receives user input, such as from a user device in communication with the digital asset system 310 over a network 398. User input may include user data submissions (e.g., biographic information, additional addresses, etc.), blockchain transaction requests, and user-signed blockchain transaction machine instructions. The transaction mediating system 315 is responsible for parsing the received user input and instructing other components of the digital asset system 310 to complete tasks necessary for the validation/rejection of the user input according to a predetermined set of conditions of constraints, as well as in some embodiments, additional external state information that is not part of the received user input, but is accessible to the digital asset system 310. The instructions to the other components of the digital asset system 310 may additionally include portions of user input (e.g., the user-signed blockchain transaction machine instructions, etc.). The transaction mediating system 315 is also responsible for returning messages to the user (e.g., to the user device illustrated in FIG. 2) including messages containing machine instructions for a blockchain transaction to a user for signature by the user. In some embodiments, the transaction mediating system 315 performs the signature verification step to confirm the sender of the message upon receiving user-signed messages.

The user identity system 330 is responsible for the storage, maintenance, update, and corroboration of provided user information and comprises a database of user information stored locally to the digital asset system 310 or externally but communicatively coupled to the digital asset system 310. User information can include, but is not limited to, biographic information (e.g., user's name, age, country of residency, etc.), associated account information (e.g., account username, password, etc.), and at least one associated holder address.

In many cryptographic protocols, a wallet address also functions as a public key for a specific, paired private key. The digital asset system 310 can collect user information from user inputs via the transaction mediating system 315 for storage on the database of the user identity system 330 and can similarly update or replace user information. In certain embodiments, the transaction mediating system 315 must verify at least one digital signature associated with a user on received transactions to instruct the user identity system 330 to update, delete, or change at least a portion of that user's user information. In some embodiments, the list of addresses associated with each account may be additionally stored on a blockchain system, such as the on-chain user identity reference storage illustrated in FIG. 1, to facilitate a blockchain node's verification of multiplicatively-signed blockchain transactions using certain cryptography protocols (e.g., ECDSA). Updates to users' associated wallet addresses (e.g., adding or removing wallet address) can be pushed to the blockchain system's distributed ledger by the digital asset system 310 submitting information update transactions to the blockchain system.

In certain embodiments, the digital asset system 310 can confirm user information before authorizing user inputs. In those embodiments, in response to user inputs the transaction mediating system 315 sends appropriate machine instructions to the user identity system 330. The user identity database then retrieves stored user information and attempts to corroborate the stored user information against information received in the instructions from the transaction mediating system 315. The user identity system 330 (which might comprise a user database) can then communicate its success or failure to corroborate the user information to the transaction mediating system 315.

In this manner, the digital asset system 310 with its user identity system 330 additionally functions as a digital wallet management system. Once a user has established an account on the user identity system 330 that includes a first digital wallet (thereby registering that first digital wallet), that user can then register additional digital wallets to their account by sending messages to the digital asset system 310 cryptographically signed by the first wallet's digital signature, which could use the private key associated with the first digital wallet. This allows the digital asset system 310, and therefore, the entity operating the digital asset system 310, to be confident of common ownership of registered digital wallets. In some embodiments, in the contingency that a user forgets or loses access to a private key associated with a registered digital wallet, the user can request that the digital asset system 310 lock the digital wallet by sending a digital message to the digital asset system 310 communicating this intent to lock a wallet address. For example, the user can request that the digital asset system 310 lock the digital wallet and the digital asset system 310 will reject all received transactions involving that digital wallet.

In those embodiments, that digital message to lock a first registered digital wallet can be cryptographically signed by a private key associated with a second registered digital wallet associated with their account on the user identity system 330. Locking the digital wallet will prevent the digital asset system 310 from approving any transactions that involve that locked digital wallet, thereby limiting the opportunity for theft or fraud. In additional embodiments, a blockchain system (which may or may not be a BVM) in communication with the digital asset system 310 can be arranged such that the blockchain system or a smart contract running on the blockchain system will allow a user to transfer of tokens from within one of the user's locked registered digital wallet to another of the user's unlocked (or not locked) registered digital wallet. In some embodiments, such a transfer from a user's locked digital wallet may only be to a pre-specified, non-locked digital wallet (e.g., recovery address or recovery wallet) also owned by the same user and for which the user must supply the private key for the non-locked, pre-specified destination wallet in order to invoke the transfer. In yet other embodiments, in addition to the destination wallet private key, the user may also have to specify other additional information, including but not limited to two factor authentication, in order to reduce the likelihood of theft or fraud.

The user financials system 335 is responsible for the storage, maintenance and operation upon of user financial information and comprises a database of user financial information stored locally to the digital asset system 310 or externally but communicatively coupled to the digital asset system 310. User financial information, stored in association to user account information, can include, but is not limited to, bank account numbers and bank account balances. In other embodiments, the user financial information can alternatively or additionally include one or more digital wallets containing a balance of tokens. In some embodiments these user balance wallets are “double signed” wallets, indicating that both the user and the digital asset system 310 must sign transactions with their cryptographic keys in order to transfer digital assets in and/or out of the wallet. In some embodiments, the user financials system 335, may be replaced with a similar user information system devoted to other information associated with a user in order to process transactions that are not specifically financial in nature. In such embodiments, the associated user information may include other personal or private information that must be examined in order to determine if a transaction satisfies various predetermined conditions and/or constraints.

In certain embodiments, the digital asset system 310 can confirm or operate on user financial information before authorizing user inputs. In those embodiments, in response to user inputs the transaction mediating system 315 sends appropriate machine instructions to the user financials system 335. The user financials system 335 can then retrieve the relevant user's financial information. In some embodiments, the user financials system 335 can confirm a minimum balance in at least one of a bank account or digital wallet equal to or greater than a relevant sum included in the user input as parsed and forwarded in the machine instructions from the transaction mediating system 315 in order to authorize a user input. In other embodiments, the user financials system 335 additionally operates on at least one account balance in a user's bank account or digital wallet in order to authorize a user input. Operations on account balances include, but are not limited to, withdrawing funds and placing a hold on at least a portion of the total balance. Operations that are holds on portions of account balances may further include a withdrawal of an equivalent or different sum at a later time under predetermined conditions. After completing any necessary operations, the user financials system 335 can then report its success or failure to the transaction mediating system 315.

The transaction machine instructions generator 320 is responsible for generating machine code for blockchain transactions in response to instructions from the transaction mediating system 315. In some embodiments, the transaction machine instructions generator 320 comprises of one or more computer programs that take inputs from a user and generates machine code for blockchain transaction. In another embodiment, the transaction machine instructions generator 320 comprises one or more computer programs that have the ability to read data from other computer programs such as metaprograms and generates machine code for blockchain transaction. In yet another embodiment, the transaction machine instructions generator 320 comprises of a hardware machine that takes input from a user or other computer programs and generates machine code for blockchain transaction. The input to the transaction machine instructions generator 320 typically includes information about the transaction sender, the recipient of the transaction, value or the amount to be transferred from sender to the recipient, data for smart contract related activities, transaction fees, etc.

For example, if user input specifies that a user would like to transfer ten tokens on the blockchain system from a certain wallet address, the transaction mediating system 315 will then send relevant information (e.g., the user's wallet address for deduction, the quantity of ten tokens, a specified destination wallet address for deposit, etc.) to the transaction machine instructions generator 320. The transaction machine instructions generator 320 then automatically formats that information into a proper machine instruction for a desired blockchain transaction. Any blockchain function call can be implemented (e.g., an ERC20 transfer transaction). In certain embodiments, the digital asset system 310 comprises a unique transaction machine instructions generator for each blockchain function call a user can utilize, and the transaction mediating system 315 then appropriately forwards required information for each blockchain function call as needed. In other embodiments, a single transaction machine instructions generator is capable of formatting received information into any blockchain function call users can utilize, and the transaction mediating system 315 informs the transaction machine instructions generator 320 as to which protocol to use for a given requested transaction.

In some embodiments, the transaction machine instructions generator 320 additionally comprises a smart contract program code generator 321. In some embodiments, the smart contract program code generator 321 comprises of one or more computer programs that takes input from a user and generates machine code for one or more blockchain smart contracts. In another embodiment, the smart contract program code generator 321 comprises of one or more computer programs that have the ability to read data from other computer programs such as metaprograms and generates machine code for one or more blockchain smart contracts. In other embodiments, the smart contract program code generator 321 comprises a hardware machine that takes input from a user or other computer programs and generates machine code for one or more blockchain smart contracts.

The input to the transaction machine instructions generator 321 typically includes information about the transaction sender, the recipient of the transaction, value or the amount to be transferred from sender to the recipient, data for smart contract related activities, transaction fees, etc. For new deployment of a contract, the data for smart contract related activities can be program code and the encoded arguments of the smart contract. For execution of a contract function, it may contain the function signature and the encoded arguments.

In some embodiments, wherein a user wants to issue derivative tokens, such as warrant or option tokens, on a quantity of (fundamental) tokens, representing a digital asset, in their possession, the blockchain system can receive one or more transactions that define the parameters of the issuance (e.g., how many issued derivative tokens, how many fundamental tokens involved with the derivative tokens, etc.) and properties of the derivative tokens, such as codified rules instructing limitations on transfer of derivative tokens, codified rules instructing exercise transactions, codified rules representing rights associated with the derivative tokens, etc. These parameters are input to the smart contract program code generator 321 which then can automatically generate bytecode for the deployment of one or more properly formatted derivatives smart contracts.

In embodiments involving derivative tokens, user input to the digital asset system 310 may include a blockchain transaction for a derivative offering that further includes derivative offering information that includes various properties of derivatives. Derivative offering information can include, but is not limited, to a derivative type, quantity of fundamental tokens involved, quantity of derivative tokens to be offered, exercise price of derivative, exercise closing date, etc. In some embodiments, the user identity system 330 and user financials system 335 can verify and/or operate on user information (e.g., user biographic information, user wallet addresses, user financial account balances, etc.) before allowing the transaction mediating system 315 to forward the derivative offering information and any other information to the transaction machine instructions generator 320.

In response to this information received from the transaction mediating system 315, the transaction machine instructions generator 320 along with its smart contract program code generator 321 procedurally creates program code of the desired one or more derivative contracts and packages them into properly formatted machine instructions for a blockchain transaction to publish the one or more derivative contracts on the blockchain system. In certain embodiments, the smart contract program code generator 321 encodes the derivative contracts to inherit at least a portion of the rules or properties of the token contract that defines the fundamental token.

In certain embodiments, the program code for the one or more derivative contracts can include machine instructions for locking or restricting the transfer of a quantity of tokens in a digital wallet of the issuer to guarantee that the fundamental tokens are available upon exercising the derivative tokens. The issuer might be the user that requested the issuance of the derivative contracts. In many embodiments, when users exercise derivative tokens to acquire fundamental tokens in a ratio and subject to any other terms encoded in the derivative contracts by the smart contract program code generator, the derivative contracts represent a transfer of the fundamental tokens from the balance of locked tokens in the issuer's digital wallet(s). In another embodiment, the program code for the derivative contracts includes at least one new wallet address, which could be a derivative contract wallet, in which to store fundamental tokens. In those embodiments, when users exercise derivative tokens to acquire fundamental tokens, the derivative contracts transfer fundamental tokens from the derivative contract wallet to the user performing the exercise transaction. Furthermore, in those embodiments in which the derivative contracts include a derivative contract wallet, the machine instructions of a blockchain transaction that publishes the derivative contracts might also include a transfer transaction of fundamental tokens from a digital wallet address of the issuer to the derivative contract wallet.

In various embodiments, the smart contract program code generator 321 encodes derivative contracts to require the digital asset system 310 to mediate at least one transaction type involving derivative tokens (e.g., a transaction calling a transfer of derivative tokens, a transaction calling an exercise of derivative tokens, etc.). In embodiments where the digital asset system 310 mediates transactions involving derivative tokens, the digital asset system 310 therefore allows those transactions to be coordinated with off-chain events, such as a withdrawal or depositing of fiat currency in a bank account.

In other embodiments, the smart contract program code generator 321 of the transaction machine instructions generator 320 can generate similar contracts to allow covered short positions of (fundamental) tokens representing a digital asset on a blockchain system. Smart contracts allowing for covered short positions can be treated as derivative contracts. In those embodiments, the derivative contracts for covered short positions allow for a temporary borrowing of fundamental tokens by the user taking the short position from another user who holds the relevant amount of fundamental tokens, under specific parameters and restrictions that are encoded into the derivative smart contracts.

Other such transactions that publish smart contracts to a blockchain system are contemplated.

In some embodiments for some transactions, the user will need to sign the machine instructions generated by the transaction machine instructions generator 320. In those embodiments, the transaction machine instructions generator 320 returns its properly formatted transaction machine instructions to the transaction mediating system 315 to be sent to the user for signature, presumably with their private key. In other embodiments for some transactions, the transaction machine instructions generator 320 forwards its properly formatted transaction machine instructions to the system signature module 325.

The system signature module 325 is responsible for signing blockchain transaction machine instructions with a digital signature associated with the digital asset system 310. The system signature module 325 receives machine instructions for blockchain transactions, which may have already been signed by one or more parties including various users, from the transaction machine instructions generator 320 or the transaction mediating system 315. The system signature module 325 can then sign the machine instructions with a digital signature associated with the digital asset system 310 and forward the system-signed machine instructions to the blockchain communications system 340. In some embodiments, the digital asset system 310 can sign machine instructions for a blockchain transaction first and subsequently send it to a user for an additional signature. In those embodiments, the system signature module 325 returns system-signed machine instructions for a blockchain transaction to the transaction mediating system 315 for forwarding to a user to sign the transaction. In certain embodiments, the digital asset system 310 may possess more than one public/private key pair resulting in more than one associated digital signature. In these embodiments, the digital asset system 310 can implement some predetermined metric or decision logic to instruct the system signature module 325 to select a certain private key for certain transactions.

The blockchain communications system 340 is responsible for receiving cryptographically signed blockchain transaction machine instructions from the system signature module 325 or the transaction mediating system 315 and submitting them to at least one node of a blockchain system via a network 399. In some embodiments, the digital asset system 310 can be in communication with a plurality of blockchain systems. In these embodiments, the blockchain communications system 340 correctly routes transactions to the appropriate blockchain system.

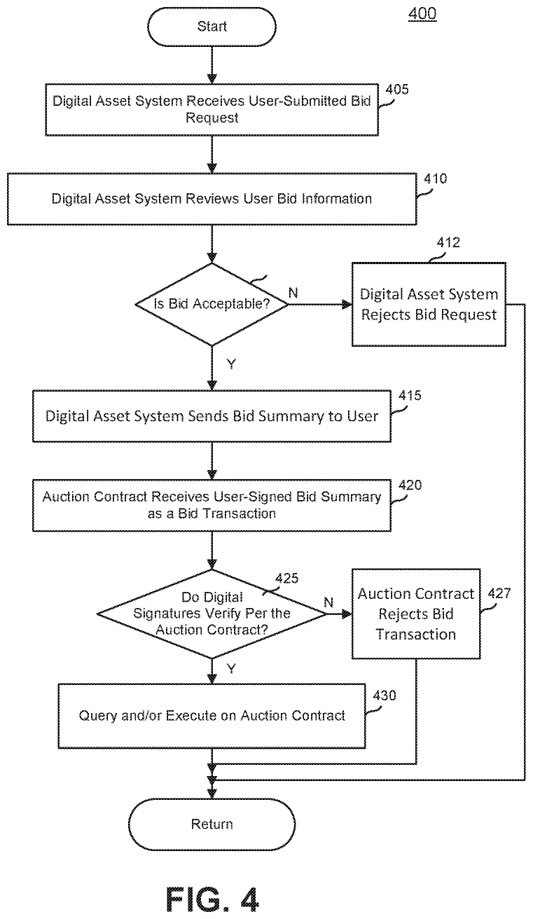

In view of the foregoing structural and functional features described above, exemplary methods may be appreciated with reference to FIG. 4. While, for purposes of simplicity of explanation, the exemplary methods illustrated in FIG. 4 are shown and described as executing serially, it is to be understood and appreciated that the present examples are not limited by the illustrated order, as some actions can in other examples or embodiments occur in different orders, multiple times, or concurrently from that shown and described herein. Moreover, it is not necessary that all described actions be performed to implement a method, as might be implemented by the system 100 illustrated in FIG. 1.

FIG. 4 shows a flowchart of a method 400 for mediating blockchain transactions requiring the system's authorization, more specifically a bid transaction as part of an auction of a digital asset represented on the blockchain network by a token with an associated token smart contract. In this example, the method might be performed by the system illustrated in FIG. 1 employing an auction contract as a smart contract on the blockchain system. At step 405 the digital asset system receives a bid request from a registered user. A registered user is one who has already established an account with the digital asset system and whose stored account information includes at least one associated holder address. A registered address is a holder address a user has previously associated with their account.

In some embodiments, the bid request comprises identification information, such as a digital signature that identifies the sender of the bid request, as well as bid information, such as an indication of funds or type of funds (e.g., fiat currency, tokens, etc.) as well as quantity of funds with which to purchase or bid on a determinate or indeterminate quantity of digital assets, such as securitized tokens. In some embodiments, the bid request can also contain machine code for executing a bid transaction on an auction contract. Users can submit bid requests to the digital asset system in a variety of ways, such as the digital asset user application illustrated in FIG. 1 implemented on a user device. In some embodiments, the transaction mediating system illustrated in FIG. 1 receives the bid request.

At step 410, the digital asset system reviews user bid information. In some embodiments, this step comprises verifying the sender of the bid request as a registered user by cross-referencing identification information, such as a digital signature, with a database of public keys of registered users. In other embodiments, this step comprises corroborating the user's financial information. For example, if a user requests to bid on digital assets with a specific amount of a specified currency (e.g., U.S. dollars, cryptographic currencies, digital tokens, etc.) the digital asset system corroborates that the user does indeed possess the specific amount of a specified currency to purchase the digital assets. In various embodiments, the digital asset system can perform this corroboration by analyzing an internal database of user financial and cryptographic account balances. In alternative embodiments, the digital asset system communicates with third-party systems that possess the financial information to perform the corroboration. In still other embodiments at step 410, the digital asset system or the third-party system having received instructions from the digital asset system upon corroborating a user's financial information and/or account balances, can additionally place a hold or lock on at least a portion of the account balances of the user. In still other embodiments, the digital asset system, or the third-party system having received instructions from the digital asset system can automatically deduct or withdraw assets from the user's account balances upon corroborating a user's financial information and/or account balances, provided that the user has granted the appropriate allowances or permissions.

In embodiments involving a user's balance of cryptocurrencies or other digital assets represented by tokens, the digital asset system can establish a double-signed wallet with the user. In many embodiments, a double-signed wallet operates and is implemented similarly to the digital wallet 106 illustrated in FIG. 1 with an additional feature that protocols for transferring cryptocurrencies or tokens into the double-signed wallet and/or protocols for transferring cryptocurrencies or tokens out of the double-signed wallet require digital signatures of both the user and the digital asset system in order for execution on a blockchain system. In some embodiments, a digital wallet could be set up to require any number of digital signatures to execute transfers.

In some embodiments, if the digital asset system fails to corroborate the financial information or receives communications from a third-party system or human agents that the corroboration has failed due to reasons such as, but not limited to, insufficient user information and/or insufficient account balances, the method proceeds to step 412 and the digital asset system rejects the bid request. In some embodiments, the digital asset system returns a rejection notification to user communicating the rejection and, in some embodiments, the reason for the rejection. In various embodiments, the user identity system and user financials system, perhaps in partnership with the transaction mediating system, illustrated in FIG. 3 perform the review, verification, corroboration, and operation upon a user's identification and financial information of step 410 as well as the rejection of the bid request of step 412. In other embodiments, the transaction mediating system illustrated in FIG. 3 performs the rejection of the bid request of step 412.

In step 415, having corroborated the user-submitted bid request, the digital asset system sends a bid summary to the user. In one embodiment, the bid summary comprises machine instructions for executing a transaction on the auction contract on the blockchain system. In some embodiments, the transaction machine instructions generator illustrated in FIG. 3 generates the machine instructions, and the transaction mediating system illustrated in FIG. 3 groups the machine instructions into a bid summary. In other embodiments, the bid summary comprises at least one digital signature generated from a cryptographic key associated with the digital asset system. In still further embodiments, the bid summary comprises additional information, such as text summarizing the intended transaction. In additional embodiments, the bid summary further comprises a nonce or timestamp. In some embodiments, if a user desires to cancel a previously requested bid request, or if a user identifies an error in the bid summary, the user may cancel the bid request by not signing the bid summary with a cryptographic signature and sending an alternative signed message to the digital asset system communicating the error or termination request.

In step 420, the auction contract implemented on the blockchain system receives a bid transaction. In many embodiments, the bid transaction comprises the analogous bid summary with at least one digital signature associated with the user and at least one digital signature associated with the digital asset system. In one embodiment, the bid transaction arrives at the auction contract by the user signing the bid summary and returning the message to the digital asset system that subsequently signs it with its own associated digital signature, such as with the system signature module illustrated in FIG. 3, and submits it to the auction contract on the blockchain system, such as by the blockchain communications system illustrated in FIG. 3. In another embodiment, the digital asset system signs the bid summary and/or the machine instructions for executing the bid transaction on the blockchain system before sending it to the user who then signs the message with their associated digital signature and submits the message as a bid transaction to the auction contract directly. Other embodiments can include any number of parties, such as, but not limited to, third-party financial accounting systems that each have associated unique digital signatures and that are constrained to sign the bid summary before submission as a bid transaction to the auction contract. In these embodiments, these additional parties can sign in any order and any party can submit the fully signed bid transaction to the auction contract without leaving the scope of this disclosure. In some cases, users could be computer systems or other themselves smart contracts, which would perform the described user actions programmatically.

In step 425, the auction contract verifies the bid transaction by verifying the plurality of cryptographic signatures in the bid transaction. In some embodiments, the auction contract must verify both the user's digital signature as well as the digital signature associated with the digital asset system in order to authenticate the bid transaction. In other embodiments, the auction contract must verify additional cryptographic digital signatures. In some embodiments, if the auction contract is unable to verify the required number of signatures, the auction contract rejects the transaction, moving the method to step 427. If the auction contract can verify the required number of signatures, the bid transaction is approved, and the method progresses to step 430.

In step 430, the auction contract than queries the blockchain and/or executes the approved bid transaction on the blockchain system. In some embodiments, the bid transaction execution comprises transferring digital assets, such as securitized tokens, to a user's digital wallet from a supply of tokens managed by the auction contract and stored in one or more auction contract wallets or other dedicated treasury smart contract wallets. In some embodiments, the step of executing the bid transaction comprises additional steps of transferring financial assets (e.g., fiat currencies, tokens, etc.) from an account or digital wallet and associated with the user to another account or digital wallet associated with a different party, such as an entity maintaining the digital asset system, as payment for the digital assets.

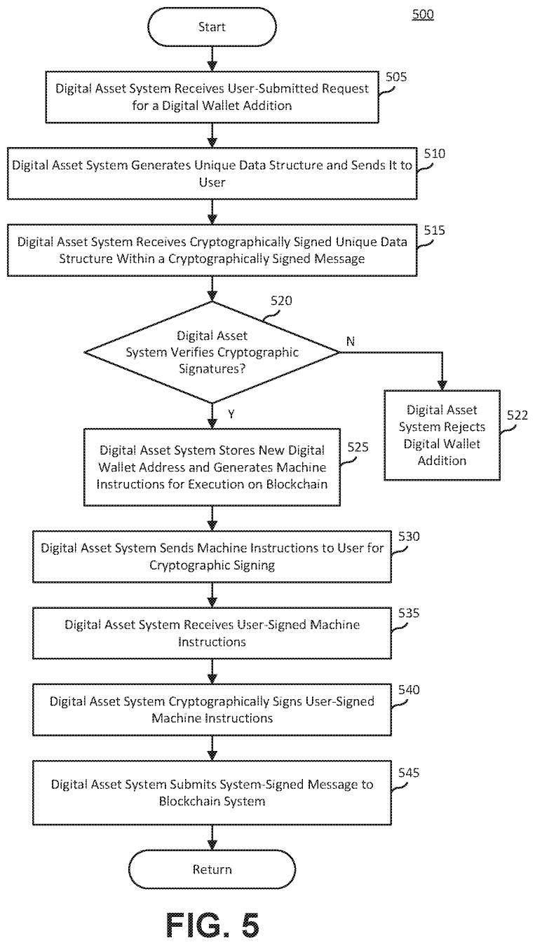

FIG. 5 illustrates a method 500 for cryptographically securing the addition of a holder address to a user's account on the digital asset system at a user's request. While, for purposes of simplicity of explanation, the exemplary methods illustrated in FIG. 5 are shown and described as executing serially, it is to be understood and appreciated that the present examples are not limited by the illustrated order, as some actions can in other examples or embodiments occur in different orders, multiple times, or concurrently from that shown and described herein. Such a method can be employed by the systems of FIGS. 1-3 in certain embodiments.

At step 505, the digital asset system receives a request to register an additional holder address from a registered user. A registered user is one who has already established an account with the digital asset system and whose stored account information includes at least one associated holder address. A registered address is a holder address a user has previously associated with their account. In certain embodiments, the request to register an additional address can come from the user device implementing the digital asset user application illustrated in FIG. 1 or FIG. 2.

At step 510, to verify that the user does indeed control the new holder address, perhaps whether the user possesses its associated private key, the digital asset system generates a unique data structure (e.g., a nonce or any other string of data) and returns it to the user. In certain embodiments, the unique data structure can be generated by the transaction machine instructions generator illustrated in FIG. 3 and communicated to the user via the transaction mediating system and network illustrated in FIG. 3.

At step 515, the digital asset system receives a digital message that is cryptographically signed with a digital signature associated with a registered address associated with the user, wherein the digital message additional includes the unique data structure that has been cryptographically signed with the private key associated with the new address that the user wishes to add to their account. In some embodiments, the user's signing process can be facilitated by the user identity list and signing module of the digital asset user application illustrated in FIG. 2. The digital message can include other information as is necessary for standard cryptographic protocols (e.g., ECDSA, RSA, etc.).

At step 520, the digital asset system verifies the digital signatures according to a cryptographic protocol (e.g., ECDSA, RSA, etc.). In some embodiments, the transaction mediating system illustrated in FIG. 3 performs this verification. If the digital asset system fails to verify both the signature of the unique data structure that corresponds to the new address and the signature of the entire digital message corresponding to a registered address of the user, the method proceeds to step 522, and the digital asset system rejects the digital wallet addition. In some embodiments, the digital asset system can additionally return an error message or failure message to the use.

If the digital asset system succeeds in verifying both signatures, the method proceeds to step 525. At step 525 the digital asset system stores the new address in association with the registered user in data storage accessible to the digital asset system. In some embodiments, this data storage can be included in the user identity system illustrated in FIG. 3. At step 525 the digital asset system also generates machine instructions for a transaction on the blockchain that stores the user's additional new registered wallet address in association with the user in a data structure on the blockchain system. Commonly-owned registered wallet addresses can be stored on the blockchain system indexed by a unique hash identifying their common ownership or via a dedicated data structure such as a map. The machine instructions are formatted according a selected blockchain transaction protocol (e.g., ERC20, etc.). In some embodiments, the data structure on the blockchain system is the on-chain user identity reference storage illustrated in FIG. 1. In some embodiments, the transaction machine instructions generator illustrated in FIG. 3 generates the machine instructions for this transaction.

At step 530, the digital asset system sends the machine instructions for the transaction to the user as a digital message. In certain embodiments, the transaction mediating system of FIG. 3 facilitates this delivery.

At step 535, the digital asset system receives user-signed machine instructions for the transaction. In some embodiments, the user identity list and signing module illustrated in FIG. 2 facilitate the user's signing of the machine instructions.

At step 540, the digital asset system cryptographically signs the user-signed machine instructions for the transaction with a digital signature associated with the digital asset system. In some embodiments, additional data can be introduced to the message for signing as is necessary for certain cryptographic protocols (e.g., ECDSA, RSA, etc.) and for certain blockchain transaction protocols. In certain embodiments, the system signature module illustrated in FIG. 3 performs the signing.

At step 545. The digital asset system submits to the blockchain the system-signed and user-signed machine instructions for adding the new address to the data storage on the blockchain system. In some embodiments, the blockchain communications system of FIG. 3 sends the final multiplicatively-signed machine instructions to the blockchain system. In some embodiments, the data storage on the blockchain system is a smart contract that can only store the address if the blockchain node processing the transaction can verify both a digital signature associated with the digital asset system and a digital signature associated with the user. In some embodiments, the data storage on the blockchain system is the on-chain user identity reference storage illustrated in FIG. 1.

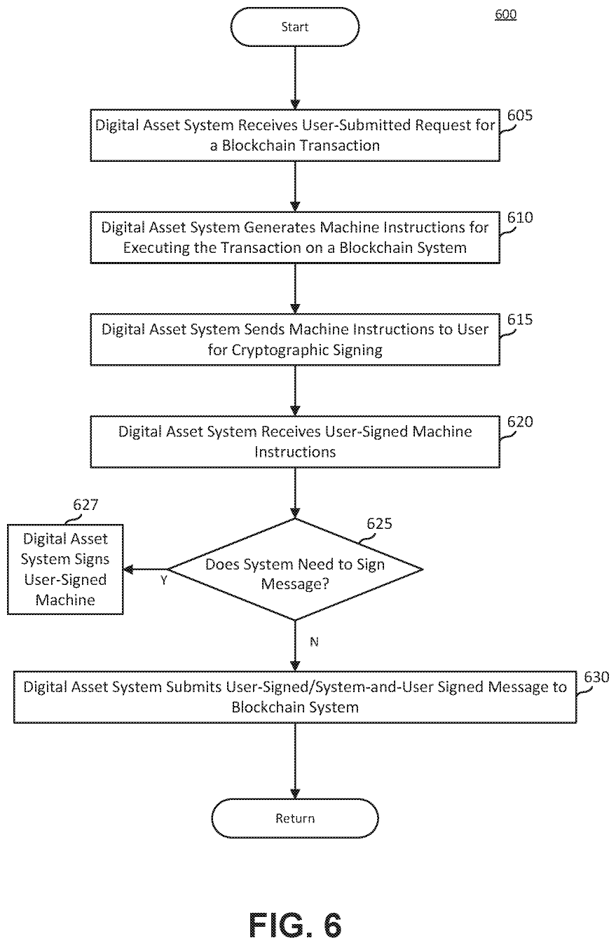

FIG. 6 illustrates a method 600 for mediating a user's desired transactions on a blockchain system using a digital asset system. While, for purposes of simplicity of explanation, the exemplary methods illustrated in FIG. 6 are shown and described as executing serially, it is to be understood and appreciated that the present examples are not limited by the illustrated order, as some actions can in other examples or embodiments occur in different orders, multiple times, or concurrently from that shown and described herein. Such a method can be employed by the systems illustrated in FIGS. 1-3 in certain embodiments.

At step 605, the digital asset system receives user input that is a digital message that communicates a request for a blockchain transaction. The user request can contain information indicating a type of transaction and its details. For example, if a user wants to transfer tokens from a digital wallet they control to another user's digital wallet, the user request can contain a data structure indicating the type of transaction, such as a transfer, a quantity of tokens to transfer, a digital wallet from which the user wants to send tokens, and the address of the intended recipient. In another example, the request can be for a bid on an auction contract. In certain embodiments for certain types of transactions, the digital asset system can corroborate or operate on user information available to the digital asset system, such as in the user identity system or the user financials system illustrated in FIG. 3, before proceeding to step 610. In some embodiments, the transaction mediating system illustrated in FIG. 3 receives the user request.

At step 610, the digital asset system generates machine instructions for executing the desired transaction on a blockchain system. In many embodiments, this step includes formatting the requested transaction type and details from the user request into a properly formatted blockchain system function call (e.g., an ERC20 transfer transaction, a transaction that publishes one or more derivative contracts). In some embodiments, the transaction machine instructions generator illustrated in FIG. 3 generates the machine instructions.

At step 615, the digital asset system sends the machine instructions to the user as part of a digital message. The digital message can include other information as is required for a given network protocol in various embodiments. In some embodiments, the transaction mediating system illustrated in FIG. 3 sends the digital message comprising the machine instructions for the transaction to the user after having received the machine instructions from the transaction machine instructions generator illustrated in FIG. 3.

At step 620, the digital asset system receives from the user a digital message that comprises a digital signature associated with the user of the machine instructions for the desired transaction. In some embodiments, the digital asset system can verify the digital signature to confirm the sender of the signed machine instructions. In some embodiments, the transaction mediating system illustrated in FIG. 3 receives the digital message and performs the verification.

At step 625, the digital asset system decides whether the system needs to additionally sign the machine instructions for executing the transaction with a digital signature associated with the digital asset system. In some embodiments, certain transactions, such as transfer transaction, cannot require a digital signature associated with the digital asset system. In some embodiments, certain transaction, such as transactions that coordinate with off-chain events or external state information like a bid transaction involving a quantity of fiat currency, can require a digital signature associated with the digital asset system. In many embodiments, the necessity or otherwise for a digital signature associated with the digital asset system on machine instructions for a specific blockchain depends upon the specific implementation of the blockchain system and/or smart contracts operating on the blockchain system. If the digital asset system determines that a signature associated with the digital asset system is required, the method proceeds to step 627. If the digital asset system determines that a signature associated with the digital asset system is not required, the method proceeds to step 630. In some embodiments, the transaction mediating system illustrated in FIG. 3 makes this determination according to a predefined rule-set.

At step 627, the digital asset system signs the user-signed machine instructions with a digital signature associated with the digital asset system. In some embodiments, additional data can be appended to the message for signing as is necessary for certain cryptographic protocols (e.g., ECDSA, RSA, etc.) and for certain blockchain network protocols. In certain embodiments, the system signature module illustrated in FIG. 3 performs the signing.

At step 630, the digital asset system submits the digital message comprising the machine instructions to the blockchain system. If the transaction requires a signature associated with the digital asset system, then the digital message comprises the machine instructions for the transaction, a digital signature associated with the user, and a digital signature associated with the digital asset system. If the transaction does not require a signature associated with the digital asset system, then the digital message comprises the machine instructions for the transaction and a digital signature associated with the user. In certain embodiments, the digital message can comprise additional information as is necessary for certain cryptographic protocols and certain blockchain function calls. In some embodiments, the blockchain communications system illustrated in FIG. 3 submits the digital message containing the singly- or multiplicatively-signed machine instructions to the blockchain system.

FIGS. 7-9 illustrate flows among computer systems operated by various parties. In each instance, parties might use a computer system trusted and controlled by a respective party to initiate an interaction such as a transaction. For example, an issuer of a security might use an issuer computer and a payment processor might use a payment processor computer. A network manager computer might be used by a network manager to create and inject a smart contract into a distributed network such as a blockchain ledger system. Thus, it should be understood that each element of those figures might be implemented by a computer system, program code, data, memory, and other elements to give effect to inputs of each of the components. In a system implemented according to one or more of FIGS. 7-9, the network operator system might be a digital asset transaction and management system and might be implemented using elements illustrated in FIG. 3.

FIG. 7 shows a block diagram of a digital derivatives system 700 that can be used for the issuance, and exercise of more advanced financial instruments like derivatives such as warrants, options, shorts etc. on a blockchain system. Digital asset system 720 can be used for digital asset system 310 and user financials system 725 can be used for user financials system 335 illustrated in FIG. 3 in some embodiments. In certain embodiments, token holders 715 can issue derivatives on the digital derivatives system 700 using the digital asset system 720. In other embodiments token holders 715 can directly work with the digital derivatives system 700 and issue derivatives on the blockchain system. Other contemplated embodiments of the digital derivatives system 700 might include alternative groupings, arrangements, and selections of the parts depicted in FIG. 7. In other embodiments, certain functionalities can be redistributed as alternative implementations in a greater, fewer, or equivalent number of components.

The digital derivatives system 700, which is one or more computing systems, comprises a digital asset system 720 that token holders 715 and token issuer 710 transact with for dealing with any transactions related to financial instruments such as security tokens, derivatives etc. The digital asset system 720 might comprise one of more computing systems including a user financials system 725 that stores and operates on users' financial information (e.g., bank account numbers, balances), a token contract 750 that is setup on the blockchain by the token issuer 710 using the digital asset system 720 for issuance of financial instruments such as security tokens, bonds, etc., and an escrowed derivative contract system 730 comprising derivative contracts 740 and exchange contracts 745 that are set up by digital asset system 720 for the issuance of derivative tokens and/or exercise or exchange of derivative tokens for fundamental tokens.

The individual or organization that is responsible for issuing the securities associated with a token is referred to as the token issuer 710. A token might be a voucher implemented in a BVM that represents something of value, such as goods or services or future revenue, currency, or a unit of exchange. Tokens may represent securities interests, such as, but not limited to, shares of equity, units of debt, or contractual rights to a dividend or royalty.

Token contracts 750 are a type of smart contract that can record and perform actions with already existing tokens, generate or issue new tokens, and execute various transactions involving tokens. The token issuer 710 is generally responsible for publicly identifying the address of the token contract associated with the issued security and would be involved, directly or indirectly through a third party, with the implementation of the token contract. In some embodiments, the issuer 710 provides all the necessary parameters and details of the token structure to the digital asset system 720 which in turn manually or programmatically generates program code for the token contract 750 and sends a transaction to the blockchain system to deploy the smart contract.

An individual or organization that has a nonzero balance of tokens is referred to as a token holder 715. A token holder 715 would normally associate their holdings with one or more addresses under their control. A token holder 715 can use funds deposited in a user financial system 335 to purchase or exercise security tokens or derivatives.

The user financials system 725 is responsible for the storage, maintenance and operation upon of user financial information and comprises a database of user financial information stored locally to the digital asset system 720 or externally but communicatively coupled to the digital asset system 720. User financial information, stored in association to user account information, can include, but is not limited to, bank account numbers and bank account balances. In other embodiments, the user financial information can alternatively or additionally include one or more digital wallets containing a balance of tokens. In some embodiments these user balance wallets are “double signed” wallets, indicating that both the user and the digital asset system 720 must sign transactions with their cryptographic keys in order to transfer cryptocurrency in and/or out of the wallet.

In certain embodiments, the digital asset system 720 can confirm or operate on user financial information before authorizing user inputs. In some embodiments, the user financials system 725 can confirm a minimum balance in at least one of a bank account or digital wallet equal to or greater than a relevant sum in order to authorize a user input. In other embodiments, the user financials system 725 additionally operates on at least one account balance in a user's bank account or digital wallet in order to authorize a user input. Operations on account balances include, but are not limited to, withdrawing funds and placing a hold on at least a portion of the total balance. Operations that are holds on portions of account balances may further include a withdrawal of an equivalent or different sum at a later time under predetermined conditions.

In some embodiments, the user financials system 725 can verify and/or operate on user information (e.g., user biographic information, user wallet addresses, user financial account balances, etc.) before allowing the user transaction to issue or exchange derivatives.

Derivatives can be escrowed or non-escrowed. For issuance of escrowed derivatives, the user has to have a quantity of fundamental tokens in their possession. In this case the user is either the token issuer 710 or token holder 715. For issuance of non-escrowed derivatives, the user need not have any fundamental tokens in their possession.

In examples where a token issuer 710 or token holder 715 wants to issue derivative tokens, such as warrant or option tokens, on a quantity of fundamental tokens in their possession to guarantee that the fundamental tokens are available upon exercising the derivative tokens, the digital asset system 720 can receive a transaction that includes the parameters of the issuance (e.g., how many issued derivative tokens, how many contracts involved fundamental tokens, etc.) and properties of the derivative tokens, such as codified rules instructing limitations on transfer of derivative tokens, codified rules instructing exercise transactions, etc. In these examples, user input to the digital asset system 720 may include a blockchain transaction request for a derivative offering that further includes derivative offering information.

Derivative offering information can include, but is not limited, to a derivative type, quantity of fundamental tokens involved, quantity of derivative tokens to be offered, exercise price of derivative, etc. In some embodiments, user financials system 725 can verify and/or operate on user information (e.g., user biographic information, user wallet addresses, user financial account balances, etc.) before allowing the user transaction for creating escrowed derivative contracts system 730.

In response to this information from the user digital asset system 720 and its components procedurally creates program code of the desired escrowed derivative contract system 730 comprising of one or more derivative contracts 740 and one or more exercise contracts 745 and packages them into properly formatted machine instructions for a blockchain transaction to publish them on the blockchain system. In certain embodiments, the derivative contracts 740 inherit at least a portion of the rules or properties of the token contract 750 that defines the fundamental token.

In certain embodiments, the program code for the one or more derivative contracts 740 can include machine instructions for locking or restricting the transfer of a quantity of tokens in a digital wallet of the issuer to guarantee that the fundamental tokens are available upon exercising the derivative tokens. The issuer might be the user that requested the issuance of the derivative contracts 740.

In certain embodiments, the program code for the one or more exercise contracts 745 can include machine instructions for exchanging derivative tokens for fundamental tokens upon exercising the derivative tokens or for reclaiming the fundamental tokens from the escrow on expiration of the derivatives.

In some embodiments, user financials system 725 can verify and/or operate on user information (e.g., user biographic information, user wallet addresses, user financial account balances, etc.) before allowing the user transaction for exercising derivatives which includes exchanging derivative tokens with fundamental tokens.

In examples where the user who is not in possession of the fundamental token wants to issue derivative tokens, such as warrant or option tokens, the digital asset system 720 can receive a transaction that includes the parameters of the issuance (e.g., how many issued derivative tokens, etc.) and properties of the derivative tokens, such as codified rules instructing limitations on transfer of derivative tokens, codified rules instructing exercise transactions, etc. In these examples, user input to the digital asset system 720 may include a blockchain transaction request for a derivative offering that further includes derivative offering information.

Derivative offering information can include, but is not limited, to a derivative type, quantity of fundamental tokens involved, quantity of derivative tokens to be offered, exercise price of derivative, etc. In some embodiments, user financials system 725 can verify and/or operate on user information (e.g., user biographic information, user wallet addresses, user financial account balances, etc.) before allowing the user transaction for creating non-escrowed derivative contracts system 760.

In response to this information from the user digital asset system 720 and its components procedurally creates program code of the desired non-escrowed derivative contracts system 760 packages them into properly formatted machine instructions for a blockchain transaction to publish them on the blockchain system.

In many embodiments, when users exercise derivative tokens to acquire fundamental tokens in a ratio and subject to any other terms encoded in the derivative contracts by the smart contract program code generator, the derivative contracts represent a transfer of the fundamental tokens from the balance of locked tokens in the issuer's digital wallet(s).

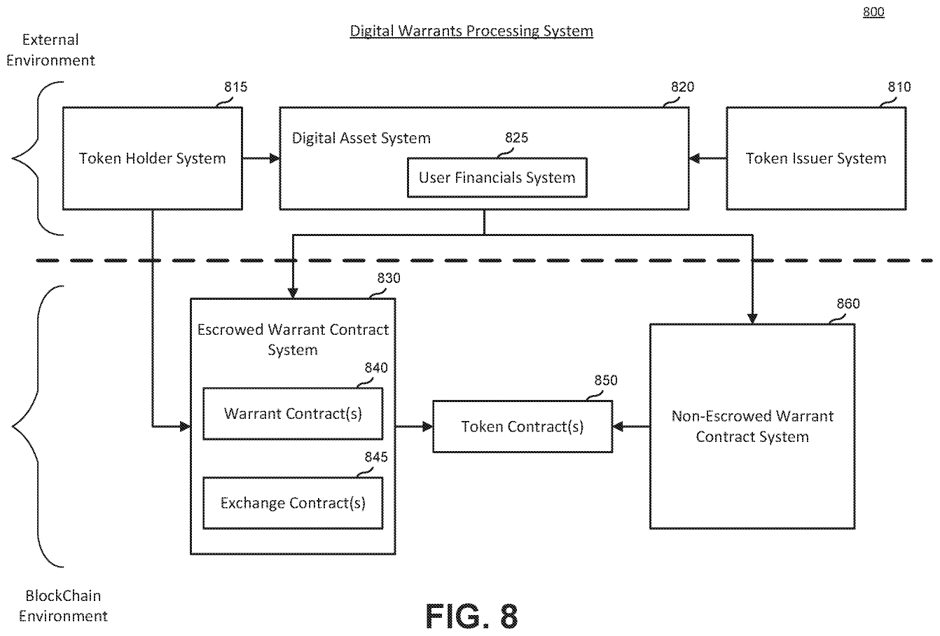

FIG. 8 illustrates an example of a digital warrant system 800. Digital warrant system 800 might be a specific example of a digital derivatives system as illustrated in FIG. 7 and described in the above embodiments.

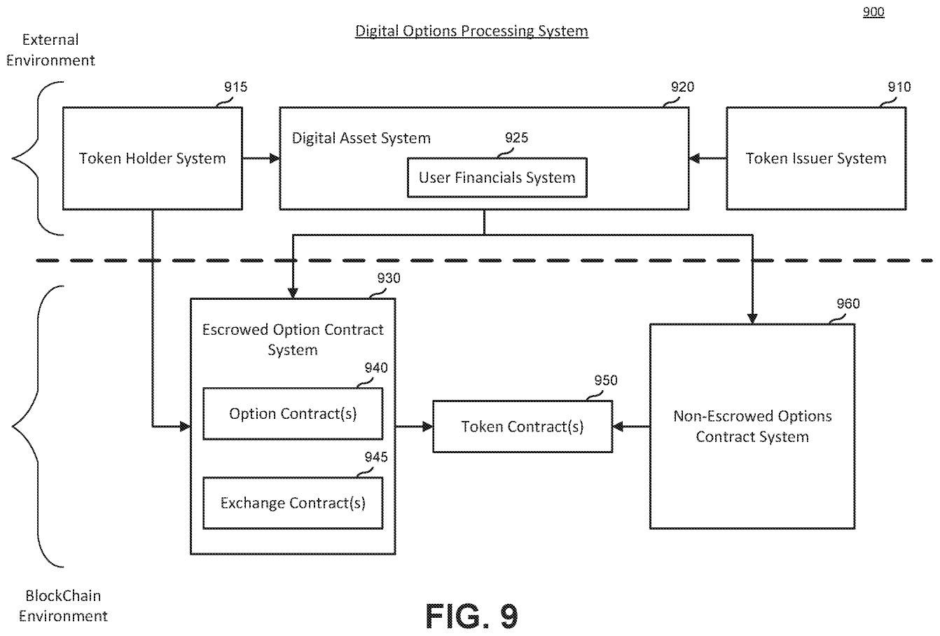

FIG. 9 illustrates an example of a digital options system 900. Digital options system 900 might be a specific example of a digital derivatives system as illustrated in FIG. 7 and described in the above embodiments.

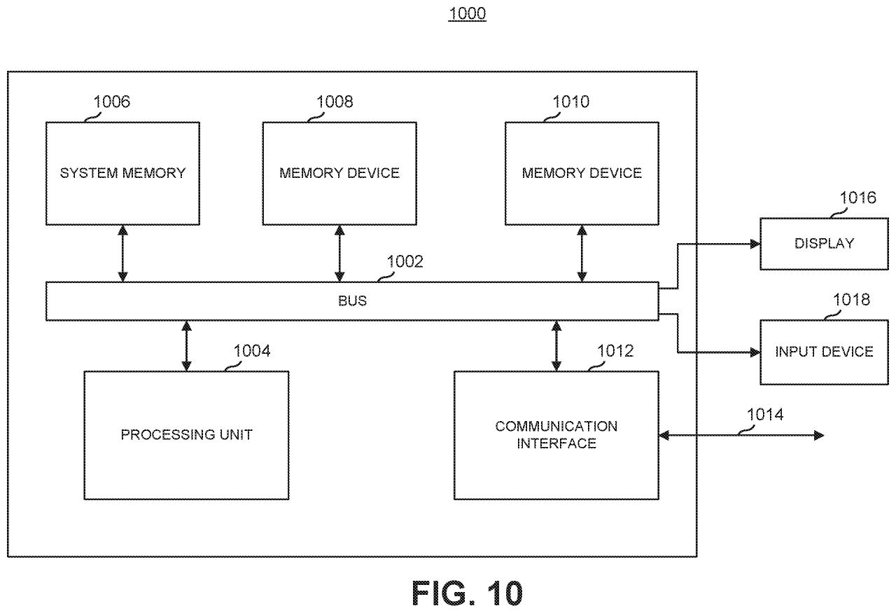

FIG. 10 illustrates an example of a computer system 1000 that can implement examples of the systems and methods disclosed in FIGS. 1-9. For example, computer system 1000 might be used to implement a node or other processor described herein.

The computer system 1000 can utilize on one or more general purpose networked computer systems, embedded computer systems, routers, switches, server devices, client devices, various intermediate devices/nodes and/or stand-alone computer systems. Given the distributed nature of the blockchain system, the illustrated computer system 1000 can be one of a plurality of computer systems that execute nodes of the blockchain system. Alternatively, the illustrated computer system can represent a user device implementing a digital asset user application or a computer system implementing a digital asset system.

The computer system 1000 can include a system bus 1002, a processing unit 1004, a system memory 1006, memory devices 1008 and 1010, a communication interface 1012 (e.g., a network interface), a communication link 1014, a display 1016 (e.g., a video screen), and an input device 1018 (e.g., a keyboard and/or a mouse). The system bus 1002 can be in communication with the processing unit 1004 and the system memory 1006. The memory devices 1008 and 1010, such as a hard disk drive, server, stand-alone database, or other non-volatile memory, can also be in communication with the system bus 1002. The system bus 1002 interconnects the processing unit 1004, the memory devices 1006-710, the communication interface 1012, the display 1016, and the input device 1018. In some examples, the system bus 1002 also interconnects an additional port (not shown), such as a universal serial bus (USB) port.

The processing unit 1004 can be a computing device and can include an application-specific integrated circuit (ASIC). The processing unit 1004 executes a set of instructions to implement the operations of examples disclosed herein. The processing unit can include a processing core.

The memory devices 1006, 1008 and 1010 can store data, programs, instructions, database queries in text or compiled form, and any other information that can be needed to operate a computer. The computer system 1000 can implement the memory devices 1006, 1008 and 1010 can be implemented as computer-readable media (integrated or removable) such as a memory card, disk drive, compact disk (CD), or server accessible over a network. In certain examples, the data stored in the memory devices 1006, 1008 and 1010 can comprise text, images, video, and/or audio, portions of which can be available in formats comprehensible to human beings. Additionally or alternatively, the computer system 1000 can access an external data source or query source through the communication interface 1012, which can communicate with the system bus 1002 and the communication link 1014.

In operation, the computer system 1000 can implement one or more parts of a system for mediating transactions in accordance with the present embodiments. Computer executable logic for implementing various components of the system reside on one or more of the system memory 1006, and the memory devices 1008, 1010 in accordance with certain examples. The processing unit 1004 executes one or more computer executable instructions originating from the system memory 1006 and the memory devices 1008 and 1010. The term “computer readable medium” as used herein refers to any medium that participates in providing instructions to the processing unit 1004 for execution, and a computer readable medium can include multiple computer readable media each operatively connected to the processing unit.

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

Embodiments of the disclosure can be described in view of the following clauses:

1. A digital asset transaction and management system, for use in a networked computer environment, comprising:
a user information system, comprising a user identity system configured to verify and/or operate on a wallet database in response to machine instructions received by the user information system, wherein the user identity system comprises a database of addresses associated with each user of a plurality of users, and wherein the wallet database comprises records of wallet addresses and token holdings;
a transaction machine instructions generator, configured to generate machine instructions of blockchain transactions for eventual execution on a blockchain system;
a signing module that generates system-signed messages digitally signed with at least one system digital signature associated with the digital asset transaction and management system from input machine instructions;
a blockchain communications system configured to receive system-signed messages from the signing module and inject those system-signed messages into the blockchain system; and
a transaction mediating system that receives user input comprising a transaction data structure representing a first blockchain transaction and, in response to received user input, outputs a first set of generated machine instructions representing at least a part of the first blockchain transaction for eventual execution on the blockchain system to one or more of (1) the user information system, (2) the transaction machine instructions generator, (3) the signing module, and/or (4) the blockchain communications system;
wherein the transaction machine instructions generator is configured to send the first set of generated machine instructions to at least one of (1) the transaction mediating system and/or (2) the signing module, and
wherein the signing module is configured to generate the system-signed messages by signing (a) machine instructions of blockchain transactions generated by the transaction machine instructions generator, or (b) user-signed machine instructions of blockchain transactions received from the transaction mediating system.
2. The digital asset transaction and management system of clause 1, wherein the transaction data structure represents a desired blockchain transaction or user-signed machine instructions of the desired blockchain transaction.
3. The digital asset transaction and management system of clause 1 or 2, wherein the user information system further comprises a user financials system comprising a data structure including user financial information, and wherein the user financials system operates on user financial information in response to machine instructions received from the transaction mediating system.
4. The digital asset transaction and management system of clause 3, wherein the user financial information comprises one or more of account contents, user demographics, user reputation, and/or user identity as represented in the transaction mediating system.
5. The digital asset transaction and management system of any of clauses 1-4, wherein the transaction machine instructions generator further comprises a smart contract program code generator, and wherein machine instructions of a transaction for execution on the blockchain system include program code defining a smart contract comprising codified rules governing token issuance, ownership and transactions.
6. A method of facilitating transactions for a blockchain network, the method comprising: receiving, at a digital asset system, a request for a blockchain transaction;
operating on user information of a user stored in a user information system of a digital asset transaction and management system;
generating machine instructions for executing the blockchain transaction on a blockchain system; and
sending the machine instructions to the blockchain network
7. The method of clause 6, wherein operating on comprises verifying the user information.
8. The method of clause 6 or 7, further comprising: receiving, at the digital asset system, cryptographically-signed machine instructions of the blockchain transaction.
9. The method of clause 8, further comprising:
signing, with a digital signature associated with the digital asset system, the cryptographically-signed machine instructions of the blockchain transaction to form multiplicatively signed machine instructions of the blockchain transaction.
10. The method of clause 9, further comprising:
submitting, to the blockchain system, the multiplicatively signed machine instructions of the blockchain transaction.
11. A method comprising:
receiving, at a digital asset system, cryptographically signed machine instructions of a blockchain transaction for execution on a blockchain system;
signing, with a digital signature associated with the digital asset system, the cryptographically signed machine instructions; and
submitting, to the blockchain system, multiplicatively signed machine instructions of the blockchain transaction, for execution on the blockchain system.
12. A computer-implemented method for creating a blockchain transaction, comprising:
under control of one or more computer systems configured with executable instructions:
a) receiving, at a digital asset transaction and management system, a user-submitted bid request;
b) reviewing, at the digital asset transaction and management system, user bid information;
c) if the user bid information meets predetermined requirements, sending a user-signed bid summary to a user computer system;
d) generating a blockchain smart contract message containing the user-signed bid summary;
e) determine whether user signatures of the user-signed bid summary verify relative to the blockchain smart contract message; and
f) query and/or execute the blockchain smart contract message on a blockchain system.
13. The method of clause 12, further comprising:
g) signing, with a digital signature associated with the digital asset transaction and management system, a cryptographically-signed machine instructions to form multiplicatively signed machine instructions of the blockchain transaction; and
h) submitting, to the blockchain system, the multiplicatively signed machine instructions of the blockchain transaction, for execution on the blockchain system.

The term “storage media” as used herein can refer to any non-transitory media that store data and/or instructions that cause a machine to operation in a specific fashion. Such storage media may comprise non-volatile media and/or volatile media. Non-volatile media includes, for example, optical or magnetic disks. Volatile media includes dynamic memory.

Storage media is distinct from but may be used in conjunction with transmission media. Transmission media participates in transferring information between storage media. For example, transmission media includes coaxial cables, copper wire and fiber optics. Transmission media can also take the form of acoustic or light waves, such as those generated during radio-wave and infra-red data communications.

Various forms of media may be involved in carrying one or more sequences of one or more instructions to a processor for execution. For example, the instructions may initially be carried on a magnetic disk or solid-state drive of a remote computer. The remote computer can load the instructions into its dynamic memory and send the instructions over a network connection. A network interface local to a computer system can receive the data. A bus might carry the data to a main memory, from which the processor retrieves and executes the instructions. The instructions received by the main memory may optionally be stored on a storage device either before or after execution by the processor.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

1. A digital asset transaction and management system, for use in a networked computer environment, comprising:
a user information system comprising a user identity system configured to verify and/or operate on a wallet database in response to machine instructions received by the user information system, wherein the user identity system comprises a database of addresses associated with each user of a plurality of users, and wherein the wallet database comprises records of wallet addresses and token holdings;
a transaction machine instructions generator configured to generate machine instructions of blockchain transactions for execution on a blockchain system;
a signing module that generates a system-signed message digitally signed with at least one system digital signature associated with the digital asset transaction and management system from input machine instructions;
a blockchain communications system configured to receive the system-signed message from the signing module and transmit the system-signed message into the blockchain system; and
a transaction mediating system that receives user input comprising a transaction data structure representing a blockchain transaction and, in response to received user input, outputs a set of generated machine instructions representing at least a part of the blockchain transaction for execution on the blockchain system to one or more of (1) the user information system, (2) the transaction machine instructions generator, (3) the signing module, and/or (4) the blockchain communications system;
wherein the transaction machine instructions generator is configured to send the set of generated machine instructions to at least one of (1) the transaction mediating system and/or (2) the signing module, and
wherein the signing module is configured to generate the system-signed message by signing (a) machine instructions of blockchain transactions generated by the transaction machine instructions generator, or (b) user-signed machine instructions of blockchain transactions received from the transaction mediating system.

2. The digital asset transaction and management system of claim 1, wherein the transaction data structure represents a desired blockchain transaction or user-signed machine instructions of the desired blockchain transaction.

3. The digital asset transaction and management system of claim 1, wherein the user information system further comprises a user financials system comprising a data structure including user financial information, and wherein the user financials system operates on user financial information in response to machine instructions received from the transaction mediating system.

4. The digital asset transaction and management system of claim 3, wherein the user financial information comprises one or more of account contents, user demographics, user reputation, and/or user identity as represented in the transaction mediating system.

5. The digital asset transaction and management system of claim 1, wherein the transaction machine instructions generator further comprises a smart contract program code generator, and wherein machine instructions of a transaction for execution on the blockchain system include program code defining a smart contract comprising codified rules governing token issuance, ownership, and transactions.

6. A method of facilitating transactions for a blockchain network, the method comprising:
receiving, at a digital asset system, a request for a blockchain transaction;
operating on user information of a user stored in a user information system of a digital asset transaction and management system;
generating machine instructions for executing the blockchain transaction on a blockchain system; and
sending the machine instructions to the blockchain network.

7. The method of claim 6, wherein operating on comprises verifying the user information.

8. The method of claim 6, further comprising: receiving, at the digital asset system, cryptographically signed machine instructions of the blockchain transaction.

9. The method of claim 8, further comprising: signing, with a digital signature associated with the digital asset system, the cryptographically signed machine instructions of the blockchain transaction to form multiplicatively signed machine instructions of the blockchain transaction.

10. The method of claim 9, further comprising: submitting, to the blockchain system, the multiplicatively signed machine instructions of the blockchain transaction.

11-13. (canceled)

14. A non-transitory computer-readable medium storing instructions, which when executed by a processor, cause a system to perform operations for executing a digital asset transaction, the operations comprising:
verifying, by a user information system, a user identity on a wallet database, wherein the user information system comprises a database of addresses associated with each user of a plurality of users, and wherein the wallet database comprises records of wallet addresses and token holdings;
generating, by a transaction machine instructions generator, machine instructions of blockchain transactions for execution on a blockchain system;
generating, by a signing module, a system-signed message digitally signed with a system digital signature associated with the digital asset transaction;
receiving, by a blockchain communications system, the system-signed message from the signing module and transmitting the system-signed message to the blockchain system;
receiving user input comprising a transaction data structure representing a blockchain transaction;
in response to receiving the user input, outputting, by a transaction mediating system, a set of generated machine instructions representing at least a part of a blockchain transaction for execution on the blockchain system to one or more of (1) the user information system, (2) the transaction machine instructions generator, (3) the signing module, and/or (4) the blockchain communications system;
sending the set of generated machine instructions to at least one of (1) the transaction mediating system and/or (2) the signing module, and
wherein the system-signed message is digitally signed by (a) machine instructions of blockchain transactions generated by the transaction machine instructions generator, or (b) user-signed machine instructions of blockchain transactions received from the transaction mediating system.

15. The non-transitory computer-readable medium of claim 14, wherein the token holdings are associated with a security interest or contract.

16. The non-transitory computer-readable medium of claim 14, wherein the user information system further comprises a user financials system comprising a data structure including user financial information, and wherein the user financials system operates on user financial information in response to machine instructions received from the transaction mediating system.

17. The non-transitory computer-readable medium of claim 16, wherein the user financial information comprises one or more of account contents, user demographics, user reputation, and/or user identity as represented in the transaction mediating system.

18. The non-transitory computer-readable medium of claim 14, wherein the transaction machine instructions generator further comprises a smart contract program code generator, and wherein machine instructions of a transaction for execution on the blockchain system include program code defining a smart contract comprising codified rules governing token issuance, ownership, and transactions.

19. The non-transitory computer-readable medium of claim 14, wherein the operations further comprise: receiving cryptographically-signed machine instructions of the blockchain transaction.

20. The non-transitory computer-readable medium of claim 14 wherein the operations further comprise: submitting, to the blockchain system, the multiplicatively signed machine instructions of the blockchain transaction.

21. The non-transitory computer-readable medium of claim 14 wherein the operations further comprise: adding a user blockchain address to an on-chain address database or map.

22. The non-transitory computer-readable medium of claim 14 wherein the operations further comprise: determining whether the blockchain transaction satisfies predetermined rules based on a contract.

23. The non-transitory computer-readable medium of claim 14 wherein the blockchain transaction is associated with a distributed ledger of a blockchain network.
